(19) United States
(12) Patent Application Publication
(10) Pub. No.: US 2014/0135954 A1
(43) Pub. Date: May 15, 2014

(54) Balance-assist shoe

(71) Applicant: John M. Vranish, Crofton, MD (US)

(72) Inventor: John M. Vranish, Crofton, MD (US)

(21) Appl. No.: 13/694,257

(22) Filed: Nov. 13, 2012

(51) Int. Cl. A63F 13/12; A43B 3/00

(52) U.S. Cl. CPC A63F 13/12; A43B 3/0005
USPC 700/91; 36/83

(57) ABSTRACT

A Balance-Assist Shoe system is described in which the shoes measure proximity and alignment to any surface prior to and after contact and force distribution during contact. The proximity and force sensing are first discussed in general terms as several sensing technologies apply. This is followed by a more detailed discussion where proximity and force sensing are performed by capacitance. An exercise system and a playback & analysis system, useful in using the Balance-Assist Shoes, are also described with attention to a situation awareness headset. The situation awareness headset, in turn, facilitates a PC media application which is useful, but unrelated to its original purpose.

### CROSS REFERENCE TO RELATED APPLICATION

The invention is related to an invention shown and described in Vranish, J. M., McConnell, R., Driven-Shield Capacitive Sensor, U.S. Pat. No. 5,166,679, Nov. 24, 1992. The rights to this invention are held by the United States Government. The invention is also related to an invention shown and described in Vranish, J. M., Current-Measuring Operational Amplifier Circuits, U.S. Pat. No. 5,515,001, May 7, 1996. The rights to this invention are also held by the United States Government. The invention is also related to an invention shown and described in Vranish, J. M., Rahim, W., Phase-Discriminating Capacitive Array Sensor System, U.S. Pat. No. 5,214,388, May 25, 1993, European patent 93850112.9, May 28, 1993, designated states DE FR GB. The rights to this invention are also held by the United States Government. The invention is also related to an invention shown and described in Vranish, J. M., “Capaciflector” Camera, U.S. Pat. No. 5,373,245, Dec. 13, 1994. The rights to this invention are also held by the United States Government. The invention is also related to an invention shown and described in Vranish, J. M., Device, System and Method for a Sensing Electric Circuit, U.S. Pat. No. 7,622,907, Nov. 24, 2009. [“Driven Ground”]. The rights to this invention are also held by the United States Government.

### CROSS REFERENCE TO RELATED APPLICATION

The invention is related to inventions shown and described in Vranish, J. M., McConnell, R., Driven-Shield Capacitive Sensor, U.S. Pat. No. 5,166,679, Nov. 24, 1992, Vranish, J. M., Current-Measuring Operational Amplifier Circuits, U.S. Pat. No. 5,515,001, May 7, 1996, Vranish, J. M., Rahim, W., Phase-Discriminating Capacitive Array Sensor System, U.S. Pat. No. 5,214,388, May 25, 1993, European patent 93850112.9, May 28, 1993, designated states DE FR GB, Vranish, J. M., “Capaciflector” Camera, U.S. Pat. No. 5,373,245, Dec. 13, 1994. [16]. Vranish, J. M., Device, System and Method for a Sensing Electric Circuit, U.S. Pat. No. 7,622,907, Nov. 24, 2009. [“Driven Ground”]. The teachings of these related applications are herein meant to be incorporated by reference.

### ORIGIN OF THE INVENTION

The invention was made by John M. Vranish as President of Vranish Innovative Technologies LLC and may be used by John M. Vranish and Vranish Innovative Technologies LLC without the payment of any royalties therein or therefore. John M. Vranish is a former employee of NASA and worked on the problem of using capacitance for proximity and precision position and alignment while at NASA. This invention is a continuation of his NASA work but, done by John M. Vranish on his own time and at his own expense.

### BACKGROUND OF THE INVENTION

The idea for the Balance-Assist Shoe originated from a U.S. Army Colonel, Bedford “Buck” Boylston who was interning at NASA Goddard Space Flight Center in the 2011-2012 time frame. Colonel Boylston (now retired) was also an army surgeon with extensive experience in Afghanistan and Iraq where he had experienced dealing with soldiers who had lost limbs in combat. NASA technology transfer official Darryl R. Mitchell, suggested “Buck” and John M. Vranish meet to see if NASA “Capaciflector” technology could be applied. These meetings led to further meetings with people in the Bethesda Naval Hospital who were working with amputees and to later meetings between “Buck” and the NASA Johnson Space Center who were working on the Robonaut project. The Bethesda Naval Hospital contacts provided insight and information on what amputees needed. The Robonaut project led in a different direction. The Robonaut project has a relationship with Nike in which resistive technology is used for force sensing on the foot. A web search on Nike and shoe R&D led to Nike discussing a relationship with Apple whereby a runner could obtain GPS information about his/her route from a wireless mini package inserted in the shoe. Considering all these factors, to the inventor it seemed prudent to develop an invention that both appealed to the running community market and that met the needs of the Wounded Warrior project, so the Balance-Assist Shoe invention was shaped with both sets of need in mind. In pursuing a solution to these sets of needs, the project fallout naturally included recreational and business applications unrelated to the original requirements. Hence we arrive at the present form of the Balance-Shoe System invention.

### FIELD OF THE INVENTION

The invention relates generally to proximity and force sensing devices and more particularly to arrays of proximity sensors whereby alignment can be determined along with proximity to contact. The invention also relates more particularly to arrays of force sensors whereby force distributions can be measured. The invention relates generally to capacitive proximity and force sensing devices and more particularly to capacitive proximity sensing arrays and capacitive force sensing arrays whereby proximity orientation and ranges are measured and forces and force distribution are measured. The invention relates generally to headsets and to hearing aids and more particularly to headsets and hearing aids augmented by computer controlled noise cancellation and hearing enhancement. The invention relates generally to Wi-Fi and internet systems. The invention relates, generally, to playback and analysis systems and more particularly to 3-D graphical simulations used in playback and analysis systems.

### DESCRIPTION OF THE PRIOR ART

Proximity sensors and force sensors have been in common use for a long time and the art is well established and perfected. Applying proximity sensing and force sensing to shoes and feet is new. This recent need appears driven by the needs of Wounded Warrior amputees, an aging population, people with disabilities, advances in walking robots and the promise of emerging technology to act on the sensor readings to help people. Force sensing arrays using strain gauge (resistance) technology is available commercially but, force sensing arrays using capacitors is not common and the particular approach, as presented in this patent application, is unique.

Headsets with wireless communications have also been in common use for some time and this art is also well established. Wireless hearing aid technology is also well established. In both technologies sound quality is improved by suppression of background noise. There are also listening devices with a recording capability commercially available. What is unique in this patent application is separating outside sound from sound the ear is hearing and for automatically interpreting and acting on the outside sound. This includes notifying the ear when something important is going on outside and blocking outside sound when this is desired.

Simulations using 3-D animations are also well established. The 3-D animation using force and proximity sensing on exercise shoes is probably unique, but this uniqueness is in the details of the software application only.

### SUMMARY OF THE INVENTION

It is a principle object of the present invention to provide shoes instrumented with proximity and force sensors, whereby near-contact proximity and alignment measurements are recorded along with force distribution during contact. The recorded data can, then, be replayed and analyzed. In the future this data can be fed back into the nervous system to help amputees manage their artificial limbs. It is also a principle object of the present invention to use capacitance technology to perform near-contact proximity and alignment measurements and force distribution measurements during contact. It is also a principle object of the present invention to provide a playback and analysis system whereby shoe recorded data can be played back in 3-D simulation and animation and analyzed. It is also a principle object of the present invention to provide a situation awareness headset whereby sound external to the headset is monitored and analyzed while other sounds are broadcast into the operator's ear phones and when an external sound is judged important, a notification is broadcast into the operator's ear phones. It is an object of the present invention to provide an exercise system whereby the operator is informed and entertained on demand during an exercise session and is alerted to dangerous approaching vehicles. It is a further object of the present invention to provide a PC media center wherein a situation awareness headset is linked or interfaced to a personal computer, whereby a personal computer can be operated with full sound without disturbing others, but with the situation awareness headset alerting the operator to external attempts at conversation and important public announcements, with a recording capability if desired.

### BRIEF DESCRIPTION OF THE DRAWINGS

A more complete appreciation of the invention and many of its attendant advantages will be readily appreciated as the same becomes better understood by reference to the following detailed description when considered in connection with the accompanying drawings wherein:

FIG. 1 illustrates a side cutaway view of a shoe showing the location of important components.

FIG. 2 shows a bottom up view of shoe with sensor locations for sensing contact surface proximity and orientation.

FIG. 3 shows a top down view of foot and sensor locations for sensing force between shoe and foot.

FIG. 4a shows a side section view of a shoe, showing locations and orientations of proximity sensors, when the heel is closer to the contact surface than the toe.

FIG. 4b shows a side section view of a shoe, showing locations and orientations of proximity sensors, when the toe is closer to the contact surface than the heel.

FIG. 5a shows an overview block diagram of a system configured for exercise.

FIG. 5b shows an overview block diagram of system configured for playback and analysis.

FIG. 5c shows an overview block diagram of system configured as a pc media center system.

FIG. 6 shows a block diagram of exercise system a level of detail beyond overview.

FIG. 7 shows a block diagram of shoe system a level of detail beyond overview.

FIG. 8 shows a block diagram of microphone system a level of detail beyond overview.

FIG. 9 shows a block diagram of playback & analysis system a level of detail beyond overview.

FIG. 10 shows a block diagram of a pc media center system a level beyond overview.

FIG. 11a shows a shoe based on capacitive sensing, bottom up view showing outsole and out heel proximity and alignment sensors.

FIG. 11b shows a multilayer flexible, printed circuit board for shoe based on capacitive sensing showing out heel and outsole electrodes.

FIG. 12 shows a multilayer flexible, printed circuit board for shoe based on capacitive sensing showing in heel, in arch and insole electrodes.

FIG. 13a shows a side section view of a shoe, based on capacitive sensing, showing electric fields when the heel is closer to the contact surface than the toe.

FIG. 13b shows a side section view of a shoe, based on capacitive sensing, showing electric fields when the toe is closer to the contact surface than the heel.

FIG. 14a shows a side section view of a shoe, based on capacitive sensing, showing the heel and the toe both in contact with the contact surface.

FIG. 14b shows a cross section view of the electric fields in the out toe region and the out heel region when the heel and the toe are both in contact with the contact surface.

FIG. 15a shows a side section view of a shoe, based on capacitive sensing, showing the heel and the toe both in contact with the contact surface.

FIG. 15b shows a cross section view showing the electric fields, between the shoe and the foot when the heel and the toe both contact the contact surface.

FIG. 16a shows a cross section view showing the electric fields, coupling the heel, the contact surface and the driven ground, when the heel is parallel to the contact surface.

FIG. 16b shows a cross section view showing the electric fields, coupling the heel, the contact surface and the driven ground, when the heel is angled to the contact surface.

FIG. 17 shows a cross section view showing the layers in the flexible printed circuit board.

FIG. 18 shows a circuit diagram showing capacitive sensors between shoe and foot.

FIG. 19 shows a circuit diagram showing driven shield electrodes between shoe and foot.

FIG. 20a shows a diagram of a low power circuit showing capacitive sensor electrodes between shoe and foot.

FIG. 20b shows a diagram of a low power circuit showing capacitive driven shield electrodes between shoe and foot.

FIG. 21 shows a diagram of a low power circuit for proximity sensing of dielectric insulators.

FIG. 22 shows a diagram of shielding for a low power circuit for proximity sensing of dielectric insulators.

FIG. 23a shows a circuit diagram showing the composition of a driven source component.

FIG. 23b shows a circuit diagram showing the composition of a driven ground component.

### DETAILED DESCRIPTION OF PREFERRED EMBODIMENT

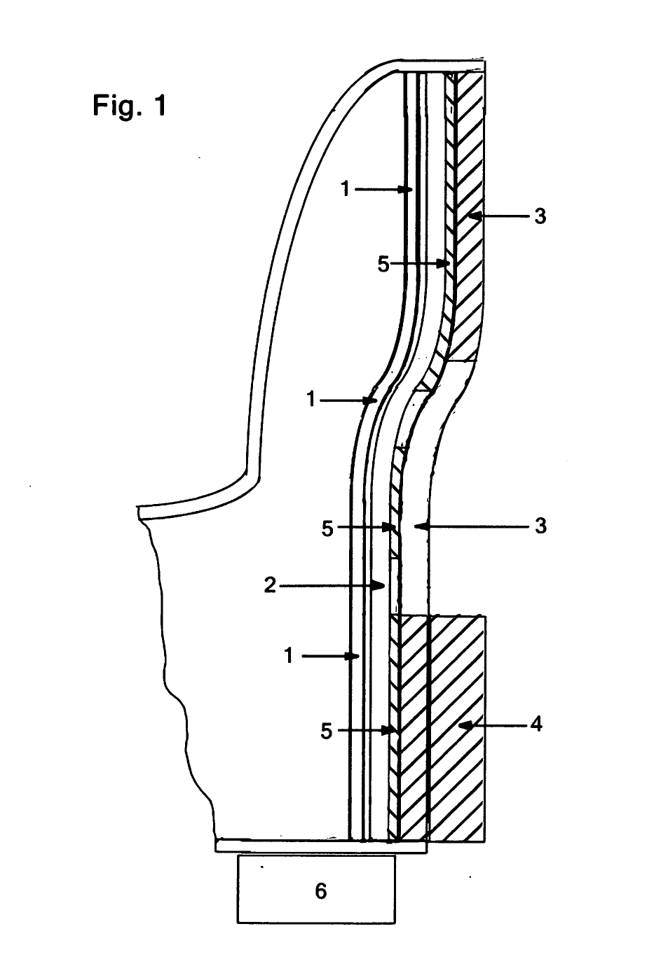

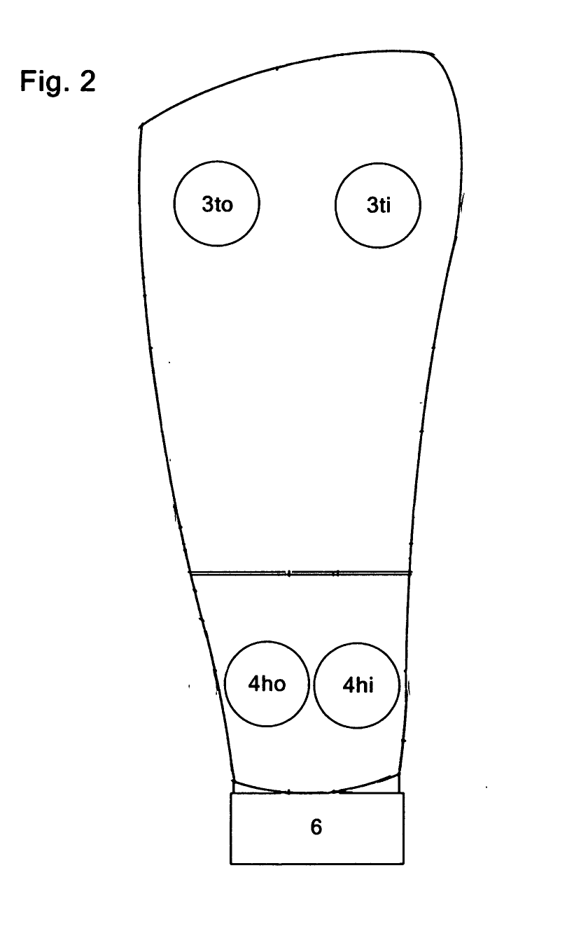

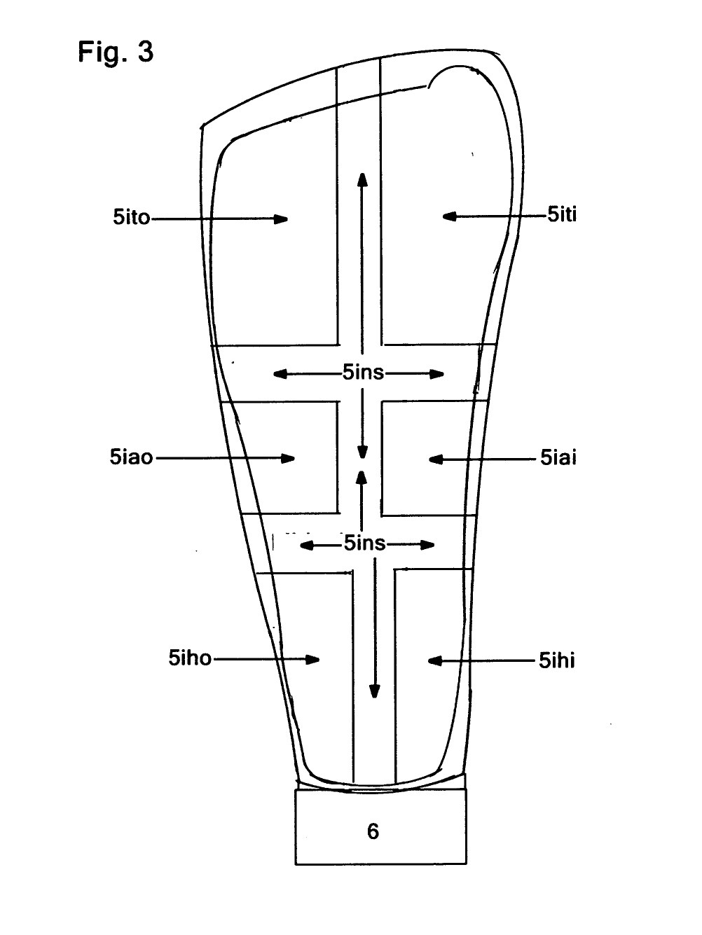

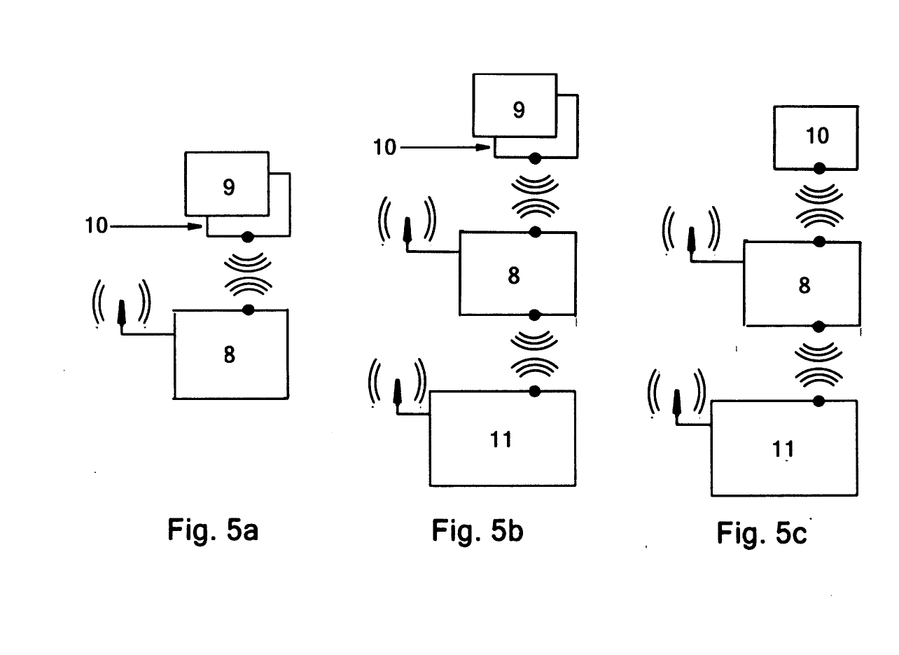

In accordance with the present invention, a Balance-Assist Shoe System uses a pair of Balance-Assist Shoes as per FIGS. 1, 2, 3, 4a and 4b as part of a Balance-Assist Shoe System which, in turn, can assume any of three system forms. These system forms include an Exercise System, FIG. 5a, a Playback & Analysis System, FIG. 5b and a PC Media Center System, FIG. 5c. The Shoes are instrumented to measure proximity to a contact surface and forces between shoe and foot during contact. This information, enhanced by internet time and GPS location information provided by the Exercise System, is recorded and used to inform the athlete of performance during exercise. The Exercise System also has a threat detection and warning system to protect the athlete during exercise. The recorded, enhanced exercise performance information is used in the Playback & Analysis System to provide after action in depth performance analysis and the Playback & Analysis System also uses the internet to enhance the playback and analysis product. The features used to make the Shoes, Exercise System and Playback & Analysis System effective provide the basis for a PC Media Center System that improves the quality of everyday PC use. The preferred embodiment first considers a systems approach using Shoe sensors with generic sensing technology because there are several sensing technologies that can be effectively used. Some of alternate technologies are listed and their performance potential briefly discussed. Of these technologies, capacitance technology seems particularly applicable. So, at this point, the discussion returns to the shoe sensing system with a focus on capacitive sensing, for both proximity and force measurements. The discussion on capacitive sensing for the shoe application uncovers some interesting possibilities in low power circuitry and driven ground circuits.

### A. BALANCE-ASSIST SHOES

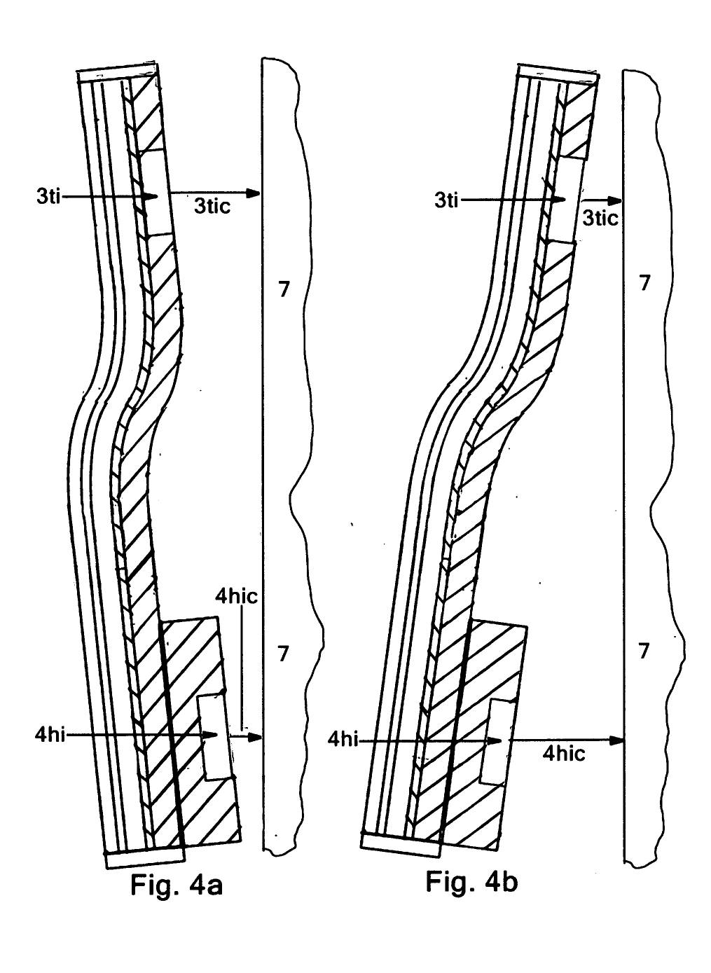

Each Balance-Assist Shoe (FIGS. 1, 2, 3, 4a, 4b) contains a set of outer toe and heel sensors, a set of Midsole sensors and an Electronics package as per FIGS. 1, 2 and 3. The outer toe proximity sensors are labeled 3to and 3ti and the outer heel proximity sensors are labeled 4ho and 4hi. The Midsole force sensors are labeled 5iho, 5ihi, 5iao, 5iai, 5ito and 5iti. (Electrical insulation separators are labeled 5ins.) The Electronics package supporting these sensors is labeled 6. The heel and toe proximity sensors each, independently, measures distance to the contact surface, labeled 7, so the measurement of all the proximity toe and heel sensors at a particular time provides information of the pre-contact orientation and location of that shoe at a moment in time. Heel proximity is measured as 4hic and 4hoc and toe proximity is measured as 3tic and 3toc. On a time frame by time frame basis, we have a picture of how each Shoe approaches and departs the contact surface. The midsole sensors (5ihi, 5iho, 5iai, 5iao, 5iti and 5ito) each, independently, measures force exerted between that sensor and the foot with the total force being the sum of the midsole sensor readings and the relative readings between the Midsole sensors measuring the distribution of forces on each foot. The forces on each foot occur during contact initiation and continue throughout contact to provide a time frame by time frame picture of the contact forces through the contact process. This provides information on how the forces build up in the heel regions at the beginning of contact and how these forces shift along the Midsole throughout the contact until they concentrate in the toe regions at push-off. But, as per FIGS. 4a and 4b, some proximity sensors are in contact with the contact surface, labeled 7, and some are not during the contact process so we have information on the shape of the shoe during contact which can be combined with the force information inside the shoe to provide a more detailed picture of runner or walker performance throughout pre-contact and contact, all on a time frame by time frame basis. Since the proximity sensors have two heel and two toe vantage points and the force sensors have two heel, two arch and two toe vantage points, we also have abundant information on how each foot rolls as it approaches, passes through and leaves contact.

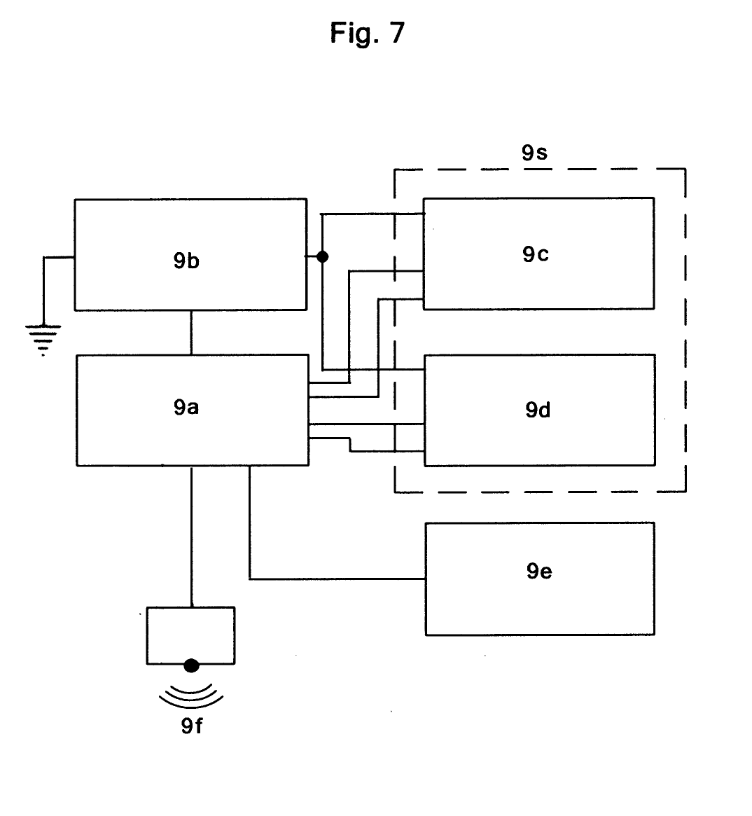

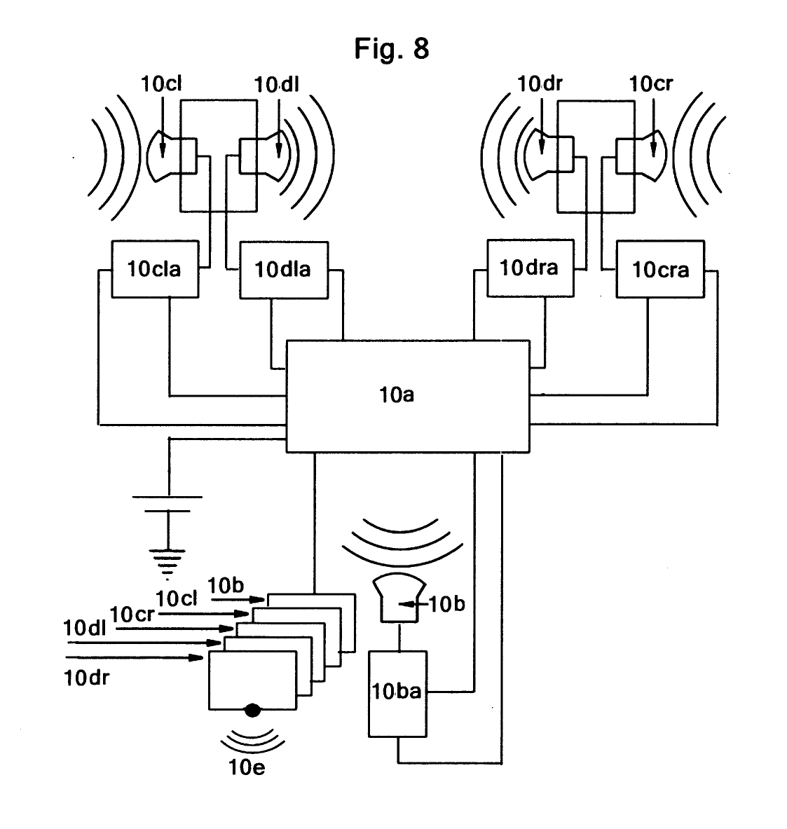

The Electronics system, 6, for each Balance-Assist Shoe as per FIG. 7, comprises a Microcontroller, 9a, a Power supply (typically a battery), 9b, proximity sensors, 9c, force sensors, 9d, a software applications library, 9e and a local wireless connection (typically Bluetooth), 9f. The readings from the proximity and force sensors can be considered in combination to provide additional useful information on how the runner or walker is performing. The proximity and force sensors are different for the left shoe and the right shoe and would be labeled 9cl and 9dl respectively for the left shoe and 9cr and 9dr respectively for the right shoe.

There are several technology options available for the sensors and the above discussion applies in general to any of the options. Proximity sensor technologies applicable to Outsole sensors include capacitive, ultrasonic, reflective infrared IR, reflective LED and miniature cameras. Technology options applicable to force sensing includes flexible printed circuit board resistive (strain gauge) sensing and capacitive sensing measuring deformation in the midsole cushion, labeled 2, FIG. 1.

### B. THE EXERCISE SYSTEM

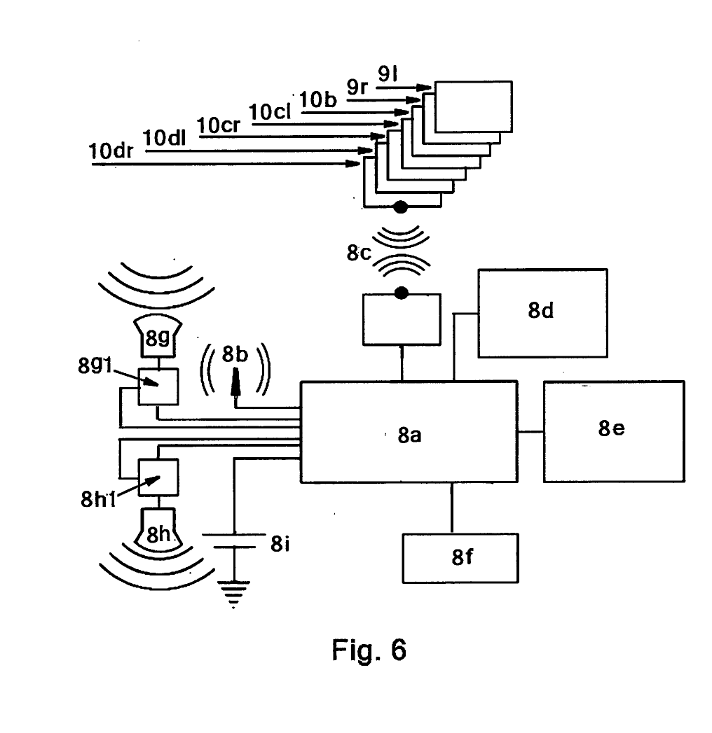

The Exercise System, FIGS. 5a, 6 comprises a pair of Balance-Assist Shoes, 9l, 9r, an Intelligent Interactive Router, 8 (8a, 8b, 8c, 8d, 8e, 8f, 8g, 8g1, 8h, 8h1, 8i) and a Headset system, 10 (10b, 10cl, 10cr, 10dl, 10dr). The Balance-Assist Shoes, the Intelligent Interactive Router and Headset are connected to each other by local wireless (typically Bluetooth) and the Intelligent Interactive Router is has an Internet and GPS capability. The Operator can request information from the Intelligent Interactive Router (IIR) by Voice Data Entry into the Headset microphone, 10b and the IIR obtains the requested information from either the Balance-Assist Shoes or the Internet and communicates the information back to the Operator by audio signal to the earphones of the Headset, 10d1, 19dr and by touch screen, 8d on the IIR The Operator can also request information through the IIR touchscreen. Information is requested and obtained on the basis of a menu with fixed choices. The information typically includes items such as Shoe performance readings and GPS readings as to location, running speed and route. Background music or news and entertainment may also be available. The IIR will be constructed along the lines of a smart phone with internet capabilities modified to address the specific needs of the Balance-Assist Shoe system. The Headset provides a means for the Operator to exercise in safety, even while the Operator is being occupied by multiple sources of information and entertainment. It does so by using ear phones that contain external ear microphones, 10cl, 10cr and internal ear speakers 10dl, 10dr. The external ear microphones pick up external noise and the internal ear speakers transmit sound to the ears. Under normal conditions, the external ear microphones act to monitor outside circumstances and to cancel the noise going into the ears so hearing information and music is as clear as possible. However, the external ear microphones also stand as a lookout to determine if an external threat, such as an automobile, is a clear and present danger. If an application in the Headset Microcontroller, 8a, determines a clear and present danger is at hand, an appropriate warning is broadcast into the ears and the Operator is immediately warned.

B1. Balance-Assist Shoes (See Description in A. Above.)

B2. Intelligent Interactive Router (IIR)

The IIR, FIGS. 5a, 6 supplies internet time reference data to the Shoes, transmits Shoe data to the Operator on request, obtains and transmits GPS location and running speed to the Operator on request. The IIR, 8 (8a, 8b, 8c, 8d, 8e, 8f, 8g, 8g1, 8h, 8h1, 8i) also communicates with the Headset (10b, 10cl, 10cr, 10dl, 10dr) so the Operator can communicate through the Headset to the IIR and from there to the Shoes 9l, 9r or to the internet. The IIR has a touch screen display, 8d, so the Operator can visually, or with voice over IP (8g microphone, 8h speaker) receive information and give commands, no hands. The IIR has a menu so communication between Operator and IIR is unambiguous. Through the IIR, the Operator can receive route information, Operator location and travel speed, by GPS location as a function of time, and performance information from the Shoe sensors as a function of time. The IIR is carried by the Operator in a smart phone sized package. The IIR is an Intelligent Interactive Router because it acquires data from the Internet, the Operator, the Shoes and the Playback and Analysis system and distributes it to other members of the network at the direction of the Operator. The IIR contains a Microprocessor, 8a, an internet connection, 8b, a local Wi Fi connection (typically Bluetooth) to the Headset, 8c and specifically to 10b (Mouth microphone), 10cl (left Ear microphone), 20cr (right Ear microphone), 10dl (left Ear speaker), 10dr (right Ear speaker) and to 9l (left Shoe) and to 9r (right Shoe). The IIR also has a software applications library 8e and a USB port, 8f.

B3. Situation Awareness Headset

The Voice over IP interface works well when the Operator wears a headset [1] Bluetooth ref Hammlicher]. But, this leaves a runner vulnerable to being hit because he/she does not hear danger approaching (such as automobiles). A one ear headset is a reasonable compromise and is commercially available [2]. But, a Selective Listening Headset, where a computer controlled and monitoring system provides lookout for any clear and present danger is a safer and better solution. A computer does not have lapses in attention. In a Selective Listening Headset, the ear pieces are each constructed with a speaker (10dl, 10dr) facing the ear and a listening microphone (10cl, 10cr) facing the outside world, with active sound isolation separating them so the ear microphones cannot hear the ear speakers and the ear cannot hear the outside world. With commercially available electret microphone and speaker technology, the construction of such a two-layered ear piece would be comparable in size and weight to off-the-shelf ear pieces. In modern hearing aids we see them small enough to be cosmetically insignificant to the wearer. Unlike a hearing aid, a Selective Listening Ear-Piece does not automatically broadcast outside sound into the ear. Rather, it uses its ear microphones (10cl, 10cr) to listen and monitor the outside world as a silent sentinel while its speakers (10dl, 10dr) cancel outside noise and pass information to the ear from a separate audio source to provide a clear, enhanced listening experience. When the silent sentinel detects something in the outside world that demands the Operator's immediate attention, the Operator is alerted and the outside world information is forwarded to the speaker on a priority basis, where it is passed to the ear and the Operator is both alerted and informed. For a runner or walker, a Selective Listening Headset allows the wearer to listen to music or monitor his/her performance under protection of the silent sentinel. When the Operator gives voice commands over the Mouth microphone (10b) his/her ears will pick up feedback through skull vibrations, thus Operator voice commands do not interfere with the enhanced safe listening system.

B4. Operator

Critical Trip Data Points (Operator location, travel speed, Shoe sensor readings and time references for each data point) are typically measured and recorded, but the Operator decides what data he/she wants to know, both during exercise and during Playback and Analysis. The Operator communicates with the IIR, by voice data entry to command the IIR and by visual display (or alternately voice data retrieval) to be informed by the IIR. The Operator can be informed about the performance of each Shoe individually or as a pair and the Operator can be informed as to route location according to GPS. The Operator can command the IIR or be informed by the IIR by menu. During post exercise analysis, the Operator can link Shoes to Playback and Analysis system through the IIR and can interact with the system through the Playback and Analysis system with the IIR used to relay information from the Shoes to the Playback and Analysis system. The Operator can link the Playback & Analysis system to the Internet using the IIR as an intermediary or alternately, the Playback & Analysis system can have its own Internet link and use the IIR network to acquire sensor data from the Shoes and correlate it with the Exerciser's GPS location.

### C. PLAYBACK & ANALYSIS SYSTEM

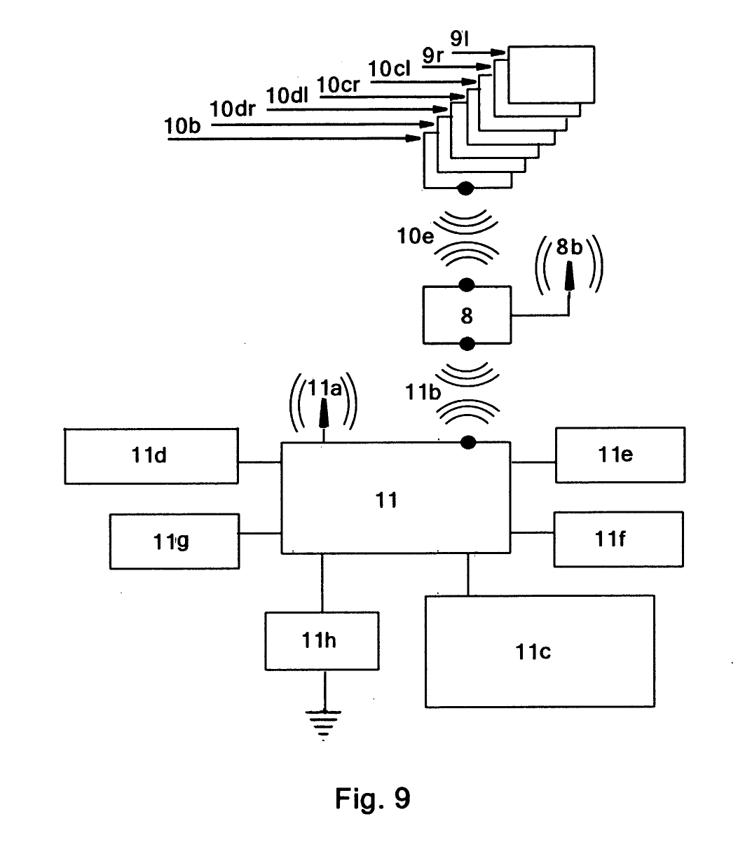

The Playback & Analysis System (PB&A), FIGS. 5b, 9 includes the Exercise System with a PC system, 11 (11a, 11b, 11c, 11d, 11e, 11f, 11g, 11h) added. The added PC system has the computer capabilities to support Playback and Analysis and has software applications that provide interactive Solid Modeling Animation specific to the sensors used in the Shoes. The software applications to support interactive Playback & Analysis are downloaded, stored and updated in the PB&A computer memory and the PB&A computer is networked into the IIR, Shoe and Operator network. Shoe software applications can also be updated from the PB&A system to the IIR and to each of the Shoes. The interactive Solid Modeling Animations show the Shoes either as a system of two or singly, on command, Stop frame action, slow motion or full speed motion viewing is also available on command. The Solid Model Animations will benefit from prior knowledge about the Operator. For example the height and weight and Shoe size may help in fitting the Shoe animations into an accurate picture of Shoe spacing and orientation. A question and answer application (FAQ) is included to provide specific answers where additional specificity is needed. Print results are available. There are two internet connections, one, 11a from the Computer, 11 and one, 8b from the IIR, 8. We now explain the labels in FIGS. 5b and 9. The Computer is labeled 11, with the PC internet connection is labeled 11a, PC local Wi-Fi link, 11b, PC power supply, 11h, PC Software Applications library, 11c, PC Keyboard entry, 11d, PC USB port, 11e, PC DVD port, 11f and PC Printer port, 11g. We also have Headset mouth microphone, 10b Left Ear microphone, 10cl, Right Ear microphone, 10cr, Left Ear speaker, 10dl, Right Ear microphone, 10dr, Left Shoe, 9l and Right Shoe, 9r. From FIG. 5b, we have the Shoes, 9, the Headset, 10 and the IIR, 8.

### D. PC MEDIA CENTER SYSTEM

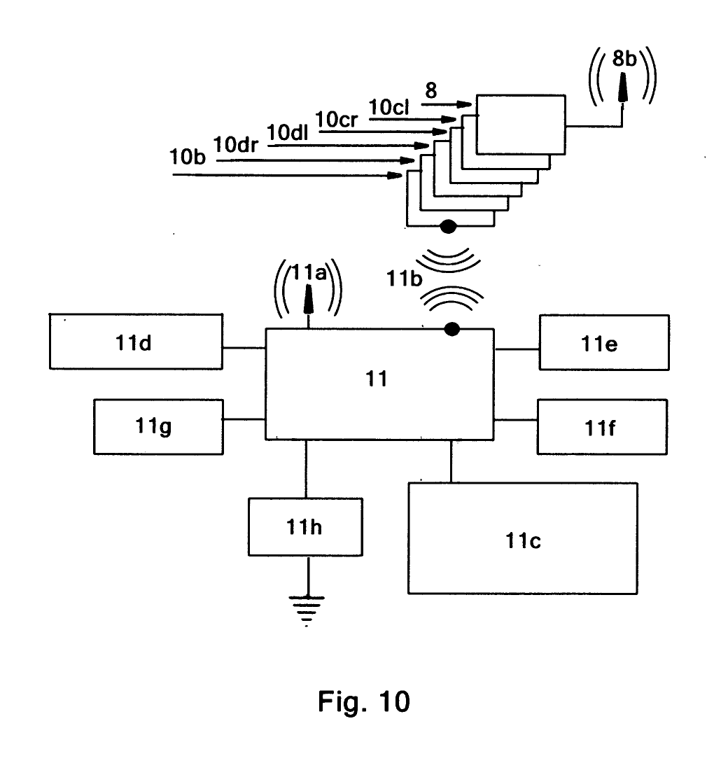

In the PC Media Center System, FIGS. 5c, 10, the Playback and Analysis System minus the Shoes can be used to enhance every day PC use. With the PC, 11, Headset, 10 and IIR, 8 Systems Wi-Fi linked into a network and further linked to the Internet an Operator can perform personal computing, carry on a no hands phone conversation, listen to music or watch a movie, all without disturbing or being disturbed by neighbors. The Headset Early Warning System now functions to cancel out undesirable background noise and alert the Operator someone is trying to speak to him/her or an important public announcement is being made. These events can also be recorded for Operator review at a later time. To prevent ethical issues for any recordings there can be an automatic erasure after a short period of time unless the Operator specifically overrides this with a command to save. From FIG. 10, we see the Operator is linked to the Internet in two separate links, one, 11a, through the PC and one, 8b, through the cell phone HR. So the Operator can simultaneously make a phone call and obtain information off the Internet. The phone call can be no hands Voice over IP and the PC activity can be keyboard, 11d or Touch Screen. Background music can be played either through the PC or the IIR. The PC can have a Wi-Fi (typically Bluetooth) link, 11b, an Applications Software Library, 9c, a USB port, 9e, a DVD port, 9f and a Printer port, 9g. PC power supply is labeled as 11h. The Headset, 10 operates with Mouth microphone, 10b, Ear microphones (Left, 10cl and Right, 10cr), Ear Speakers (Left, 10dl and Right, 10dr). The Wi-Fi link to the Headset (typically Bluetooth) is labeled as 10e. The Media Center System concept works for both Laptop and Desktop computers.

### E. WI-FI (BLUETOOTH) NETWORKS [3]

We choose a Bluetooth network because it provides a local network for small, mobile devices, because it is a widely used, standard protocol, because it is low power and because its communications are secure. Bluetooth typically uses a master slave relationship for wirelessly connected components, with one master and up to seven slaves connected together in what is termed a piconet. Two or more piconets can be linked to form what is termed a scatternet. In a scatternet, no slave can have more than one master. A unit can serve as master in one piconet and a slave in another piconet. During exercises a single piconet is required with (IIR master and Left Shoe, Right Shoe, Headset mouth microphone, Headset left ear microphone, slave, Headset right ear microphone, slave, Headset left ear speaker, slave, Headset right ear speaker, slave) (for a total of one master and seven slaves). During Playback & Analysis a PC system is added. So we create a second piconet with the PC as master and the IIR as slave. So, during Playback and Analysis, we use a scatternet comprising the exercise piconet and the PC master, IIR slave piconet. When using the PC as a Media Center, we discard the Shoes and retain the IIR, Headset and PC and use a single third piconet that is consistent with the other two piconets so we can use the same PC (typically a laptop) in both PB&A and Media Center roles. In piconet #3 (Headset Microphone is master, other 4 Headset components are slaves, Laptop & IIR are slaves) [1 master, 6 slaves]. In the Media Center application, piconets #1 and #2 are disabled. The Operator can use keyboard to physically operate the PC independent of master-slave communication protocol, while the Headset, using Voice over IP can operate piconet #3 functions to include phone function of IIR, selective listening functions of the Headset and other services such as background music or GPS location etc. (We note GPS accuracy for civilian applications was location within 20 meters (66 feet) as of May 2000). [4] This has been further reduced to 7.9-12 in. using CPGPS [5].

### F. TIMING

Timing is important in the Balance-Assist Shoe system. All data from the Shoe sensors and from the GPS locations must be referenced to a shared clock. This shared clock is chosen as that of an internet provider so we have a common understanding of when data is taken. With the time of each measurement established along with the type of measurement and the value of each measurement, we can establish speeds of the various actions of the exercise.

### G. BALANCE-ASSIST SHOES USING CAPACITIVE SENSING

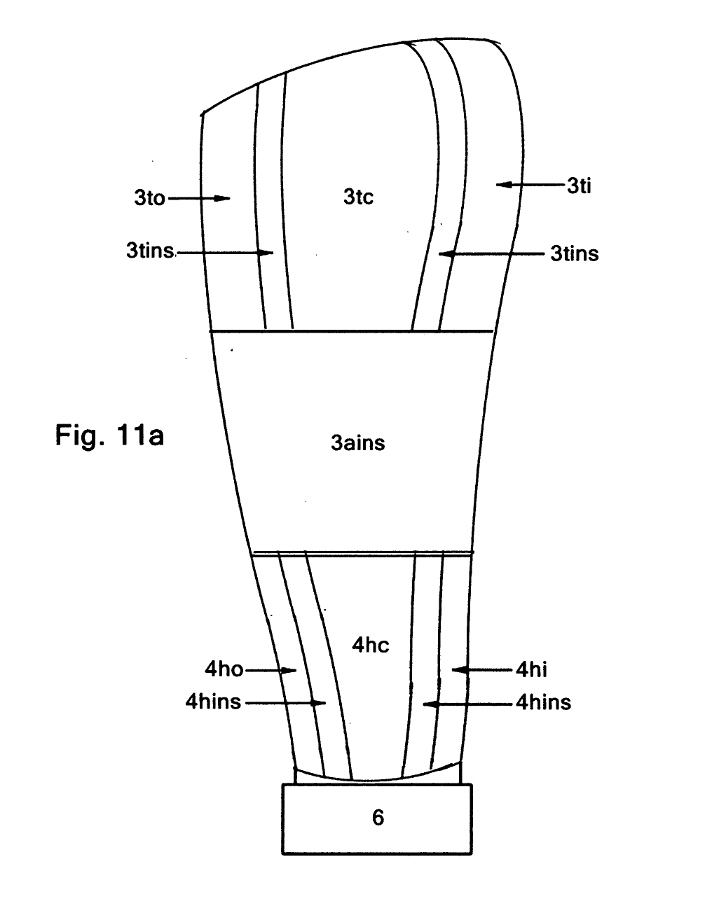

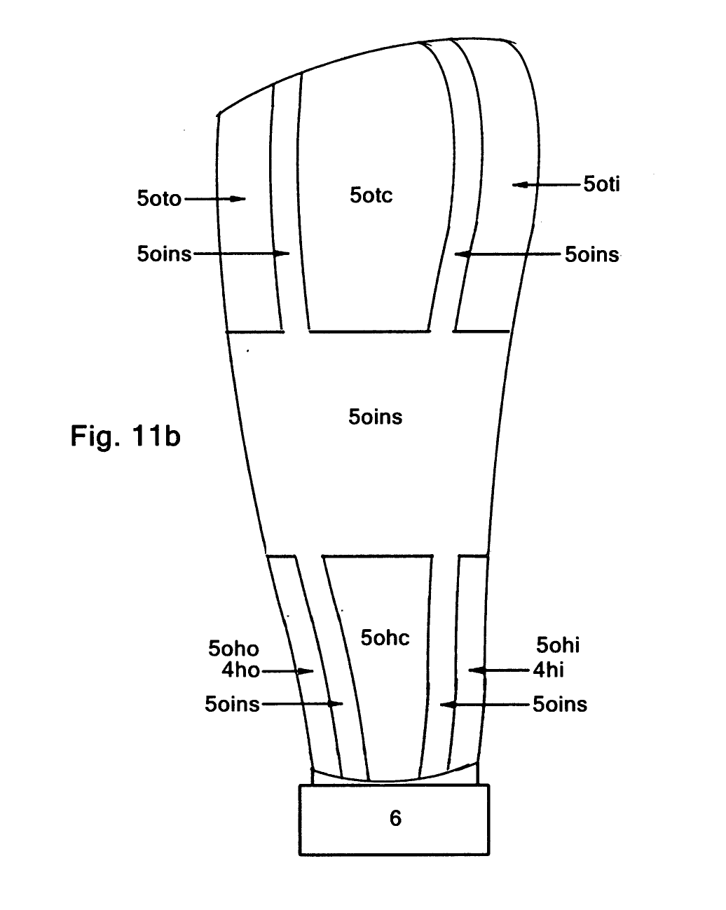

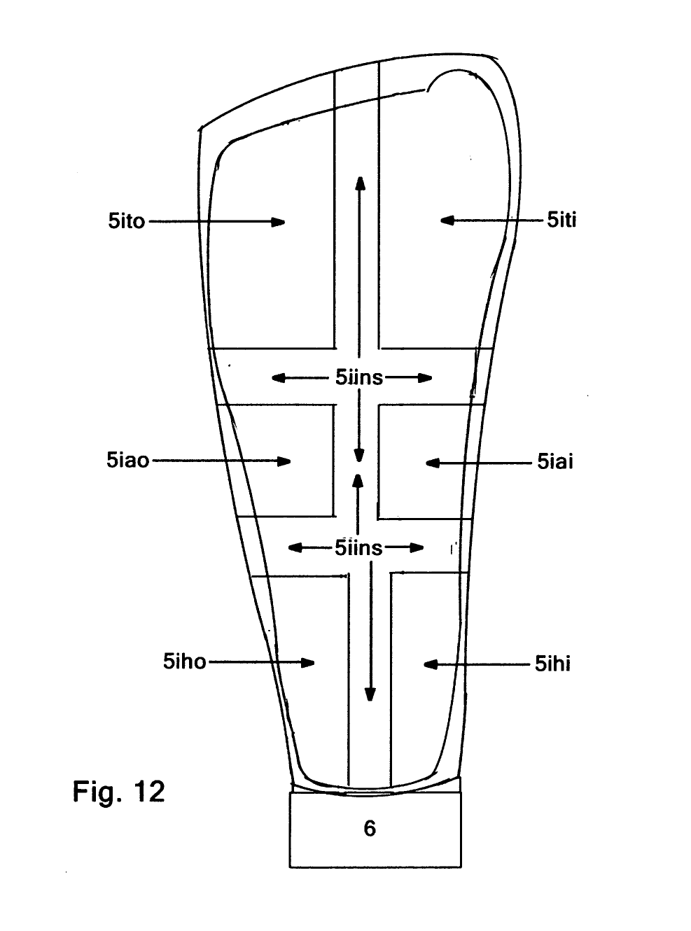

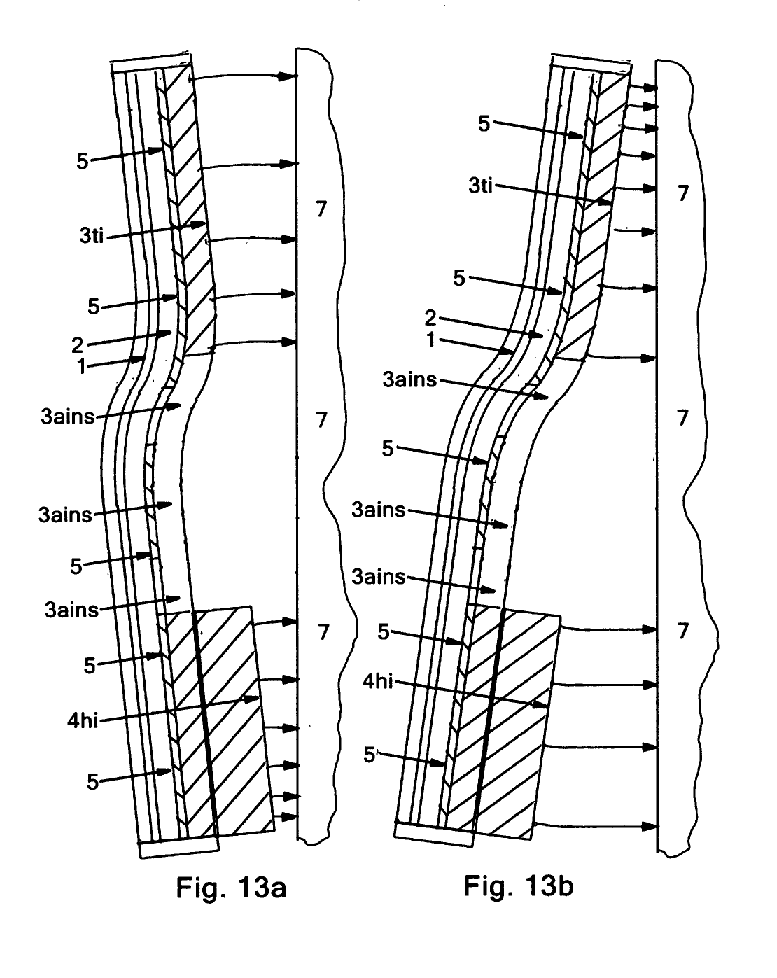

We will now focus on Balance-Assist Shoes using capacitive sensing (FIGS. 11a, 11b, 12, 13a, 13b). In the capacitive sensing version of a Balance-Assist Shoe, both proximity sensing during pre-contact and force sensing during contact can be performed using capacitive sensing. A multi-layer flexible printed circuit board, 5, provides the electrodes for the capacitive sensing, the electrodes (5ohi, 5ohc, 5oho, 5oti, 5otc, 5oto), on the outer surface, measure proximity to a contact surface and the electrodes (5ihi, 5iho, 5iai, 5iao, 5iti, 5ito), on the inner surface, measure force between Shoe and foot. The electrodes on the outer surface are separated from each other by electrical insulation areas, 5oins, and the electrodes on the inner surface are separated from each other by insulation areas, 5iins.

1. Proximity Measurements

For proximity sensing, the printed circuit board electrodes, (5ohi, 5ohc, 5oho, 5oti, 5otc, 5oto), are placed in contact with electrically conductive rubber-like material [6] [7] (4hi, 4hc, 4ho, 3ti, 3tc, 3to) respectively and the insulation areas, 5oins are in contact with electrically insulating rubber-like material, 4hins and 3tins, respectively. The rubber-like material forms the outer sole of the Shoe and performs the dual roles of extending the electrodes closer to the contact surface and of performing the mechanical functions typical of shoe soles. In extending the proximity measuring electrodes closer to the contact surface, proximity measurements are made much more accurate. As each Shoe goes through contact with the contact surface, it approaches contact heel first and the heel sensors show the largest readings. As it goes through contact, the arch and toe sensors increase and as it pushes off, the toe sensors have the largest signal. This encounter is measured on a time frame by time frame basis so we have a picture of how each Shoe is approaching, moving through and departing contact. We also can determine how each Shoe is bending during this process.

2. Force Measurements

For force measurements, the electrodes, (5ihi, 5iho, 5iai, 5iao, 5iti, 5ito) each face an electrically conductive flexible sheet, separated from the electrodes by an insulating cushioning layer, 2. When the foot forces depress the insulating cushioning layer, 2, the distance between each electrode and the electrically conductive flexible sheet, 1a, changes and we measure a change in capacitance. As each Shoe moves through contact with the contact surface, preparatory to the next stride, forces between the foot and Shoe shift both in location and amount. The electrically conductive flexible sheet and insulating cushion layer deform with this change in force distribution and the capacitance readings in electrodes 4a1 change with them. Thus, we have a measurement of distribution of forces on each foot on a time frame by time frame basis as it moves through each contact cycle.

3. Calibration

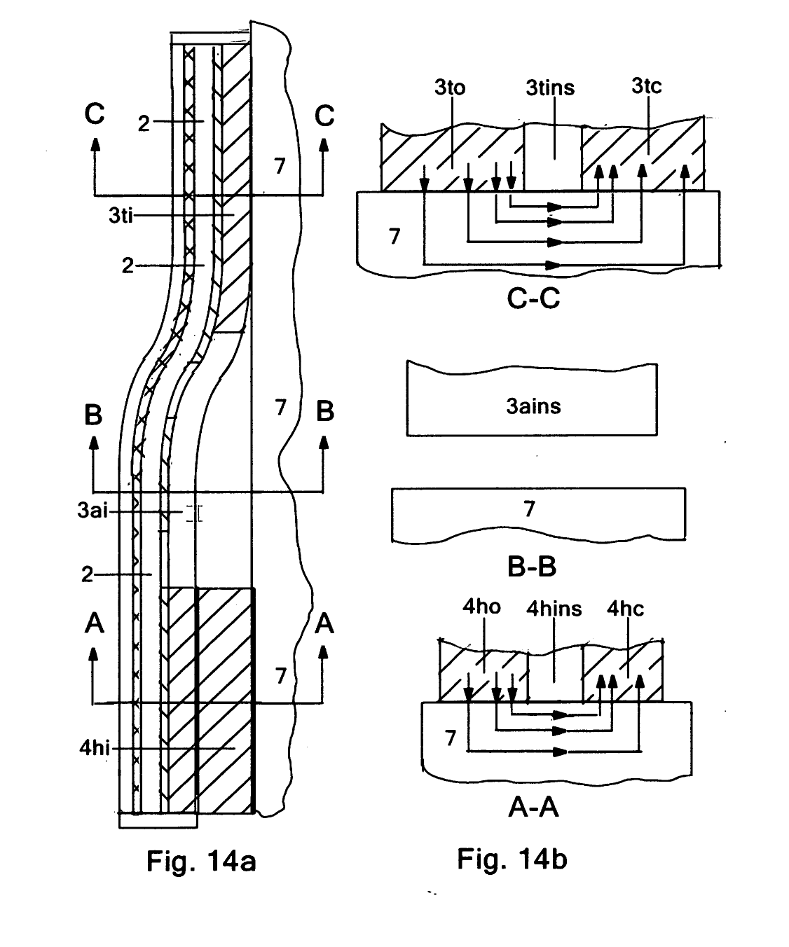

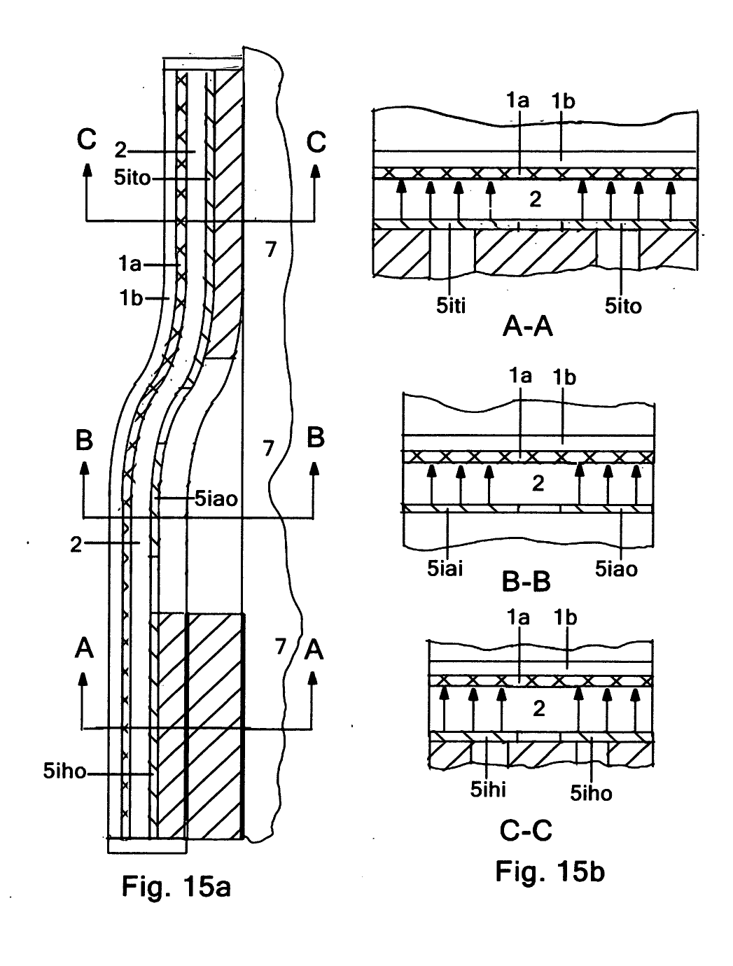

Calibration information is available when a Shoe is flat against the contact surface, 7, as per FIGS. 14a, 14b. This provides an opportunity to obtain a reading at zero clearance and to use this set of readings as a calibration set for other proximity measurements. When the force measurements are all minimal, as per FIGS. 15a, 15b, we know the Shoe is flat against the contact surface when the proximity sensors each read maximum. And, we know the forces between the foot and the Shoe are each minimal when the midsole, 2, deformation is minimal. To calibrate the force readings, we need only record the minimum force readings for (5ihi, 5iho, 5iai, 5iao, 5iti, 5ito) through each contact cycle and compare these to other readings, along with knowing the midsole spring constant, to obtain a calibrated force reading for each force sensor.

From the combination of information on proximity, force distribution and Shoe bending of each Shoe on a time frame by time frame basis, we know a great deal about the performance of the person doing the exercising.

4. Shoe Bending

Combining the proximity measurements with the force measurements and prior knowledge of Shoe shape and bending properties, enables Shoe bending to be determined during exercise. This, in turn, adds to understanding of the Exerciser's performance. For example, Force measurements during no contact conditions would act to bend the Shoe. If heel contact forces are measured during no contact conditions, we know the heel must be moving towards the contact surface with respect to the toe and the shoe must be bending. (When heel force is measured, under no contact conditions, an equal and opposite unmeasured force must be created between the shoe and the top of the foot in the toe region. These equal and opposite forces generate a torque which bends the Shoe. We have a reasonable estimate of the bending, both direction and amount, because force measurements in the heel are sufficiently precise, Toe reaction force is reasonably understood from Shoe size information and because the bending estimate can be both confirmed and refined using toe and heel proximity measurements. If toe contact forces are measured, during no contact conditions, we know the toe must be moving towards the contact surface with respect to the heel. We can estimate the amount of bending from our force measurements and knowledge of the Shoe size and characteristics. We can refine these estimates by our proximity measurements.

Shoe bending during contact with the contact surface can also be determined. Each Shoe goes through a cycle during contact in which first the heel makes contact, with the toe not in contact, followed by both heel and toe making contact, followed by the toe making contact while the heel is lifted. In each instance the forces can be compared to the proximity measurements and further compared with the knowledge of Shoe properties to provide abundant information on Exerciser performance

5. Physical Sensing System

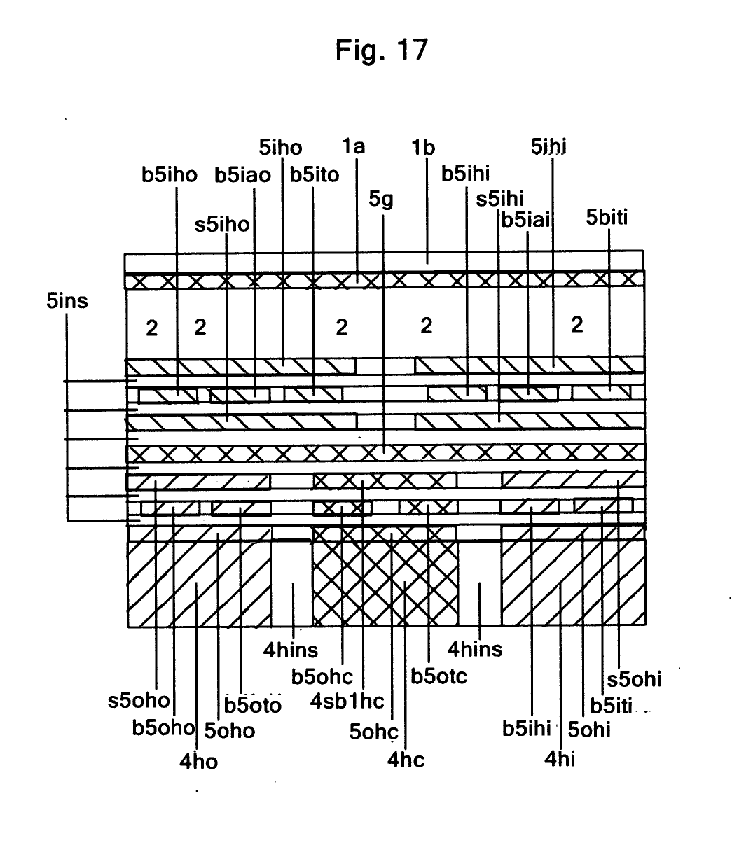

The Shoe is constructed to perform as both a sensing system and foot ware. The multilayer printed circuit board (FIG. 17) is central to the sensing system. The multilayer printed circuit board surface facing the contact surface contains the electrodes that provide the proximity sensing capabilities. The surface facing the foot contains the electrodes that provide the force sensing capabilities. The layers between the surfaces provide the shielding and buss functions needed to power the electrodes and to reduce parasitic cross-talk, leakage and noise. The proximity electrodes of the multilayer printed circuit board are connected to electrically conducting rubber-like electrodes in the heel and toe regions. In this way, the proximity electrodes are extended through the Shoe heel and toe regions and proximity measurements are more accurate. The force electrodes face a flexible conductive sheet, 1a, across an elastically deformable insulation layer midsole, 2. The insulation layer thickness is reduced under pressure from the foot and the force sensor electrodes measure this deformation as a change in capacitance. The midsole insulation layer deforms differently in different locations according to the distribution of forces on the foot and the spring constant of the deformable material. Thus, the force electrodes, measure different capacitances and we have a measurement of the distribution of forces between Shoe and foot. In Table I below, the layers of the multilayer printed circuit board are identified and described. In Table II below, the Shoe rubber-like contact structures are also described.

TABLE I
Multilayer Printed Circuit Board (FIG. 17)

| Item | Description |
|---|---|
| 5ihi | Inner heel inner electrode |
| s5ihi | Shield for heel inner electrode |
| b5ihi | Buss for heel inner electrode |
| 5iho | Inner heel outer electrode |
| s5iho | Shield for heel outer electrode |
| b5iho | Buss for heel outer electrode |
| 5iai | Inner arch inner electrode |
| s5iai | Shield for inner arch inner electrode |
| b5iai | Buss for inner arch inner electrode |
| 5iti | Inner toe inner electrode |
| s5iti | Shield for inner toe inner electrode |
| b5iti | Buss for inner toe inner electrode |
| 5ito | Inner toe outer electrode |
| s5ito | Shield for inner toe outer electrode |
| b5ito | Buss for inner toe outer electrode |
| 5ohi | Outer heel inner electrode |
| s5ohi | Shield for outer heel inner electrode |
| b5ohi | Buss for outer heel inner electrode |
| 5iho | Outer heel outer electrode |
| s5oho | Shield for outer heel outer electrode |
| b5oho | Buss for outer heel outer electrode |
| 5oti | Outer toe inner electrode |
| s5oti | Shield for outer toe inner electrode |
| b5oti | Buss for outer toe inner electrode |
| 5oto | Outer toe outer electrode |
| s5oto | Shield for outer toe outer electrode |
| b5oto | Buss for outer toe outer electrode |
| 5g | Central ground for multilayer flexible printed circuit board |
| 5ins | Insulation layers between electrodes. |

*Note:
We estimate electrode thicknesses to be 0.002 inches thick with six (6) layers = 0.012 in.
We estimate ground layer to be 0.002 in thick.
We estimate insulation layers to be 0.002 inches thick with six (6) layers = 0.012 in.
We estimate total thickness of multilayer printed circuit board to be 0.026 in.
We assume copper electrodes, busses and ground layer.
We assume Kapton insulation layers.
We note these materials and thicknesses are in line with present construction practices.

Shoe contact structure comprises rubber-like material, some of which is electrically conductive and some of which is an electrical insulator.

TABLE II
ELECTRICALLY CONDUCTIVE AND NON-CONDUCTIVE RUBBERS [7]
Shin-Etsu listed in Japan and China offers electrically conductive silicone rubber contents that
could form the basis for Out-Sole sensors. [Search: electrically conductive silicone rubber, Click
on: Shin-Etsu Silicone: Electrically conductive rubber products, find: Electrically conductive
rubber products and the EC series of products.]
This brings us to the EC series of silicone rubber compounds that have been given electrical
conductivity through the addition of carbon and other electrically conductive materials. These
are advertised for Durability Compared to electrically conductive synthetic rubbers, the rubbers
in our EC series offer superior electrical conductivity, thermal conductivity, heat and cold
resistance, and weather resistance, These products include:

| | | | Volume | |
|---|---|---|---|---|
| | | | Resistivity | |
| Type | Grade | Appearance | Ω − m | Applications |
| High electrical | EC-A | Yellowish brown | 8 × 10-5 | Prevention of |
| conductivity | | | | electromagnetic wave, |
| General purpose | EC-BL | Black | 0.009 | static protection, |
| | EC-BM | Black | 0.025 | conductive/ |
| | EC-BH | Black | 0.05 | semiconductive roles |
| High thermal | EC-TC | Black | 0.007 | |
| conductivity | | | | |

We note [7]:
$\begin{matrix}R = ρ \frac{L}{A} = 0.05 Ω - m \cdot 39.37 \frac{in}{m} \cdot \frac{L in}{A {in}^{2}} = R in ohms ( worst case ) = 72.15 \cdot \frac{L}{A} \\ \frac{L}{A} < 1 for our shoe geometry so R < 72.15 ohms and 72.15 ohms ≪ {X}_{G}\end{matrix}$ Where X_{C} is the impedance of the pre-contact air gap and is typically in kilo ohms. So, we conclude the silicone rubber is sufficiently conductive for our application.

Similar products are offered by CS Hyde Company [8]
From the CS Hyde Company search:

### Solid Silicone Electrically Conductive

Electrically Conductive Grade silicone sheeting is designed for many different applications. It is black; carbon filled silicone sheeting that acts as a low amperage conductor and provides protection against electrostatic discharge. Silicone exhibits a wish list of characteristics including superb chemical resistance, high temperature performance, good thermal and electrical resistance, long-term resiliency, and easy fabrication. It has excellent UV and ozone resistance. Silicone is odorless, tasteless, chemically inert and non-toxic. It offers low compression set and fungus resistance. Common Applications: Silicone rubber can be used for insulating and cushioning electronic assemblies. It is also used for gaskets, heat sealing and packaging, RFI/EMI Shielding. 70 Durometer. Discounts for orders of $1000, $5000

Item # Item Name Thickness Width Length List Price

71-ECD-70D-0.032 Electrically Conductive 1/32 36 in 36 in $134.84
71-ECD-70D-0.062 Electrically Conductive 1/16 36 in 36 in $173.37
71-ECD-70D-0.093 Electrically Conductive 3/32 36 in 36 in QUOTE
71-ECD-70D-0.125 Electrically Conductive ⅛ 36 in 36 in QUOTE
71-ECD-70D-0.1875 Electrically Conductive 3/16 36 in 36 in QUOTE
71-ECD-70D-0.25 Electrically Conductive ¼ 36 in 36 in QUOTE

### Results 1-6 of 6

6. Proximity Sensing Governing Equations

We will now examine the proximity measurements in more detail.

a. Dielectric Contact Surface

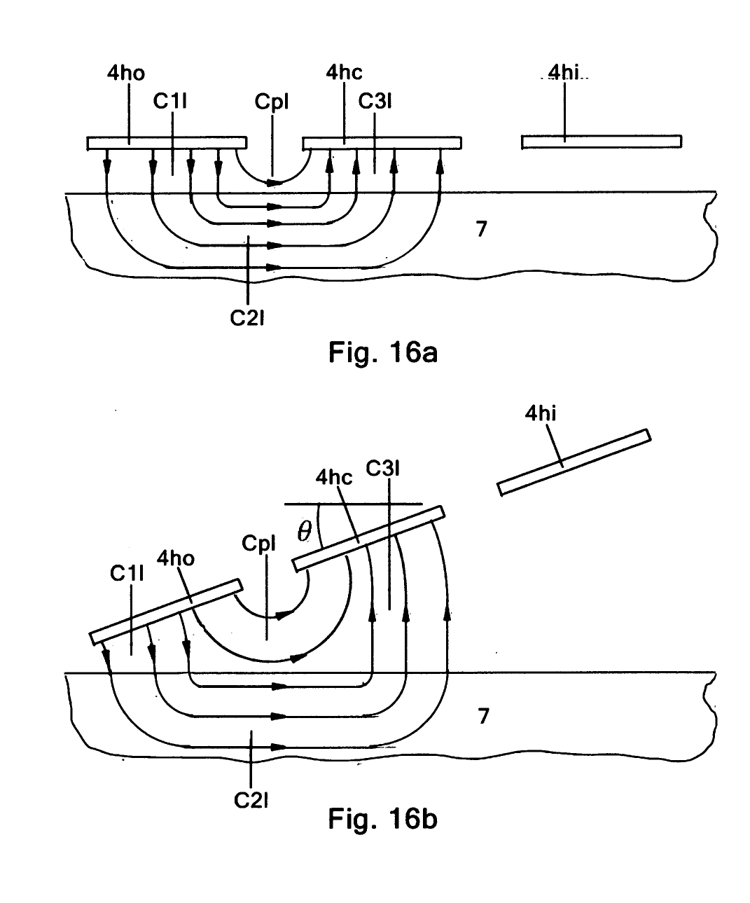

Dielectric material contact surfaces are typical of the surfaces an exerciser will be walking or running on, such as asphalt, wood, concrete, tile, sand or dirt. Because the contact material is usually an insulating dielectric, we use capacitor arrangements such as in FIGS. 16a and 16b where the outer electrodes are driven voltage sources, the inner electrode is a driven ground and the contact surface material forms a coplanar capacitor which couples the driven sources to the driven shield using three capacitors in series. By using a driven source coplanar with a driven ground we create an electric field where the field lines follow arcs between the driven source and driven ground electrodes. When a dielectric surface is encountered these field lines are disturbed and a change in capacitance is measured. The driven source measures the current that leaves the source electrode and the driven ground measures the current that arrives at the driven ground. The difference between the two amounts tells us how much current is being diverted to other grounds and phase difference between the two tells us something about the material of the dielectric. This, in turn, helps in calibrating the sensing system and making our proximity measurements more accurate. The system shown in FIGS. 16a and 16b works by alternately measuring a left coplanar capacitance and a right coplanar capacitance, with the driven ground center electrode common to both. As shown in FIG. 16b, this technique is useful in measuring any twist in the Shoe as it approaches the surface.

If the contact surface is an electrical conductor, the current at the driven ground and the current from the driven source are significantly different and when contact with the surface is made, the driven ground current goes to near zero.

If the contact surface is a dielectric insulator with a conductor buried beneath its surface, but near the surface, the readings from the Shoe sensors will provide clues as to how deep it is buried and what the dielectric insulating material is. An example of this would be steel reinforcing bars in concrete.

b. Straight Down (Parallel Plate) Approach to a Dielectric Insulator Contact Surface (FIG. 16a)

We have three capacitors in series, a parallel plate capacitor C1, in series with a form of coplanar capacitor C2, in series with another parallel plate capacitor C3 (where C3=C1 in the straight down case).

$$\begin{matrix}( eq . 1 ) & \\ \frac{1}{C} = \frac{1}{C 1} + \frac{1}{C 2} + \frac{1}{C 3} , \frac{1}{C} = \frac{2}{C 1} + \frac{1}{C 2} ( C 1 = C 3 ) & [ 9 ] \\ ( eq . 2 ) & \\ C = \frac{ɛ A}{d} & [ 10 ]\end{matrix}$$

C1 is a parallel plate capacitor, with electrodes of length L so:

$${\int }_{{X}_{1}}^{{X}_{2}} \frac{{ɛ}_{0} L}{{Y}_{0}} d X = C 1 = \frac{{ɛ}_{0}}{{Y}_{0}} L ( {X}_{2} - {X}_{1} ) \qquad ( eq . 3 )$$

(where X is along the width of the electrodes)
C2 is a type of coplanar capacitor (FIG. 16a). But, C2 is unlike typical coplanar capacitors. Typical coplanar capacitors discussed in technical writings have conductive thin, flat electrodes side by side, with an electric field that arcs from the surface(s) of one electrode to the surface(s) of the other, with energy stored in the electric field(s). The coplanar capacitor in this discussion is created because an electric field enters a dielectric flat surface medium at one location and leaves the dielectric medium at a second location while storing electrical energy in the medium in the form of dipoles in the dielectric material. We know the electric field inside the dielectric medium follows a curved path, but, without a computer simulation, we do not know the shape of the curved path. So, to be conservative, we take a worst case of a semicircle path. This leads to eq. (3) below.

$${\int }_{{X}_{1}}^{{X}_{3}} \frac{{ɛ}_{R} {ɛ}_{0} L}{π X} d X ≅ C 2 = \frac{{ɛ}_{R} {ɛ}_{0} L ( ln {X}_{3} - ln {X}_{1} )}{π} \qquad ( eq . 4 )$$

(Where X₃−X₁=width of one capacitor electrode plus half the separation distance between the two electrodes.)

### So:

$$\frac{1}{C} = \frac{1}{2 C 1} + \frac{1}{C 2} = \frac{2 {Y}_{0}}{{ɛ}_{0} L ( {X}_{2} - {X}_{1} )} + \frac{π}{{ɛ}_{0} {ɛ}_{R} L ( ln {X}_{3} - ln {X}_{1} )} \qquad ( eq . 5 )$$

Thus eq. (4) is provided as a means for estimating capacitance between coplanar electrodes with an air gap over a dielectric insulating material.
We experience parasitic effects (C_{P}) effects when the separation between C1 and C3<Y₀.
The parasitic coupling is based on coplanar conductors. It is insignificant close to contact.
We neglect C_{P} in this estimate.

$${\int }_{{X}_{1}}^{{X}_{2}} \frac{{ɛ}_{0} W}{π X} d X ≅ {C}_{P} = \frac{{ɛ}_{0} W}{π} ( ln {X}_{2} - ln {X}_{1} ) ( for {X}_{2} - {X}_{1} > {Y}_{0} ) \approx 0 ( {X}_{2} - {X}_{1} < {Y}_{0} ) \qquad ( eq . 6 )$$

c. Shoe Approaches Dielectric Insulator Contact Surface at an Angle of Twist.

We now examine the case where the foot approaches the contact surface, 7, at an angle of twist, FIG. 16b.

$$\frac{1}{C} = \frac{1}{C 1} + \frac{1}{C 2} + \frac{1}{C 3} \\ ( from eq . ( 1 ) , capacitors in series ) \\ dC = \frac{{ɛ}_{0} LdX}{{Y}_{0} + X tan θ} , C = \frac{{ɛ}_{0} L}{{Y}_{0}} ln \vert {Y}_{0} + X tan θ \vert \qquad ( eq . 7 )$$

### (X₂ to X₁ (for C1) and X₄ to X₃ (for C3).)

### So:

$$C 1 = \frac{{ɛ}_{0} L}{{Y}_{0}} ( ln \vert {Y}_{0} + {X}_{2} tan θ \vert - ln \vert {Y}_{0} + {X}_{1} tan θ \vert ) \qquad ( eq . 8 )$$

### And:

$$C 3 = \frac{{ɛ}_{0} L}{{Y}_{0}} ( ln \vert {Y}_{0} + {X}_{4} tan θ \vert - ln \vert {Y}_{0} + {X}_{3} tan θ \vert ) \qquad ( eq . 9 )$$

### So:

$${\int }_{{X}_{1}}^{{X}_{3}} \frac{{ɛ}_{R} {ɛ}_{0} L}{π X} d X ≅ C 2 = \frac{{ɛ}_{R} {ɛ}_{0} L ( ln {X}_{3} - ln {X}_{1} )}{π} \qquad ( from eq . ( 4 ) )$$

d. Performance Estimates.

From: Miscellaneous dielectric constants Table [11]
Concrete (dry) 4.5, Concrete Blocks 2.1-2.3, Bricks 3.7-4.5, Sandy Soil (dry) 2.55, Glass, Ceramic 6.0, Glass, window 6.5, Plywood 2.5, Wood (depends on type)—1.2-5 (typically 2 for “structural wood” such as chip board),

The inventor estimates Pre-Contact Sensing Range: >4 in for concrete or concrete covered tile. This estimate is based on using a frequency of 100 khz and on Capaciflector experience in the NASA robotics program during the 1980 to 1990 time frame. We were also able to see rocks at about the same range. For conductors, the detection range will extend to 12 in minimum. The blood in human beings was detectable to 12 in minimum also. Resolution improves the nearer one gets to contact. At 4 in out we should know the range +/−2 in. At 1 in we should know the range +/−0.5 in. At 0.5 in we know the range +/−0.25 in. After contact our measurements become very precise. We will know the weight distribution to less than 1 lbf. We will know the total weight and the weight distribution sufficient for purposes of balance.

In Sum, we will know enough from pre-contact sensing to know when to expect contact and where that contact is coming from. This will help us know when to slow foot movement and adjust its contact orientation. Once in contact we have all the information we need and can perform walking with balance. Once in contact, we can calibrate the pre-contact sensing in situ and determine valuable information about the ground material dielectric constant. Thus, pre-contact sensing will improve as we walk. If the ground material is an electric conductor or is covered by an electrical conductor, say metal planking, the pre-contact sensing will be very precise, but I regard this to be a rare situation.

7. Electronics

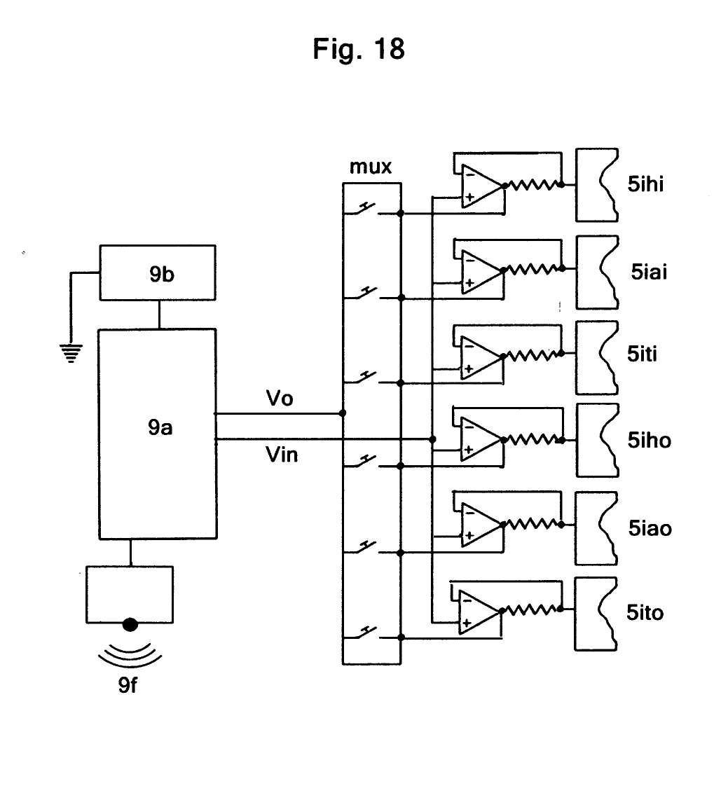

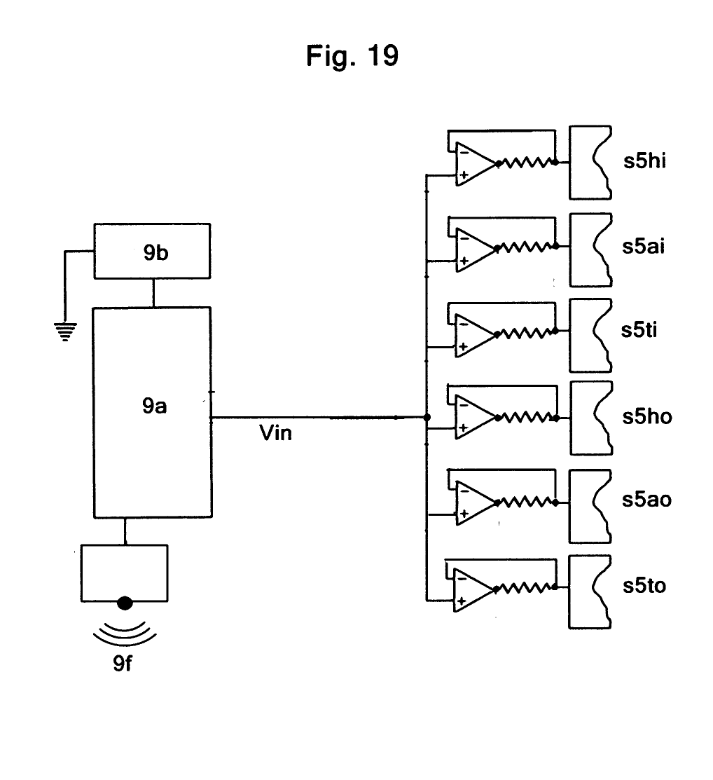

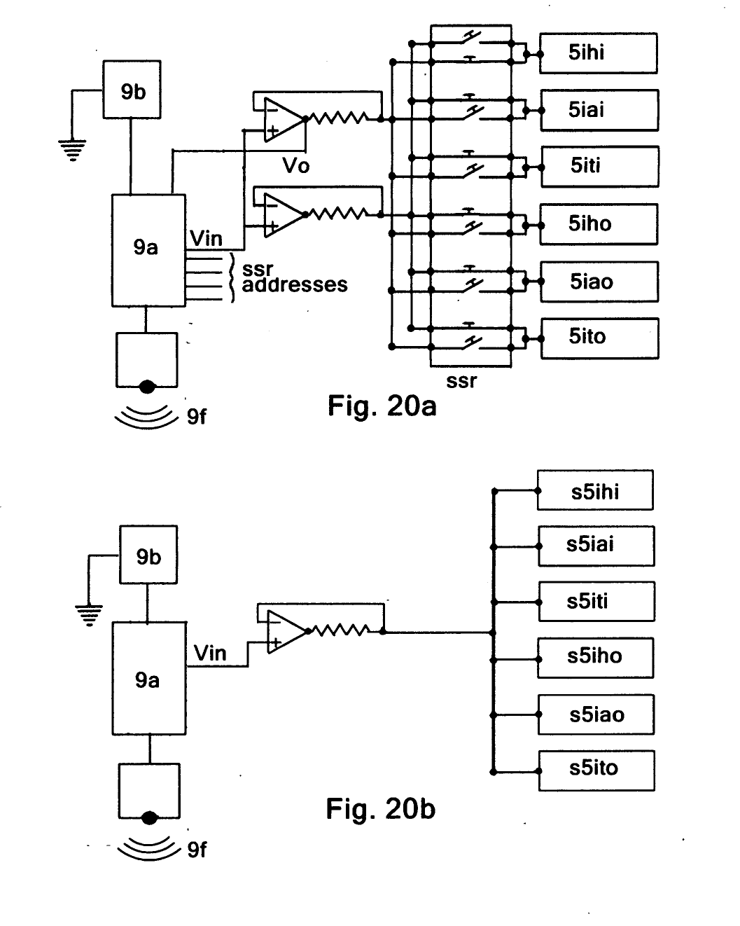

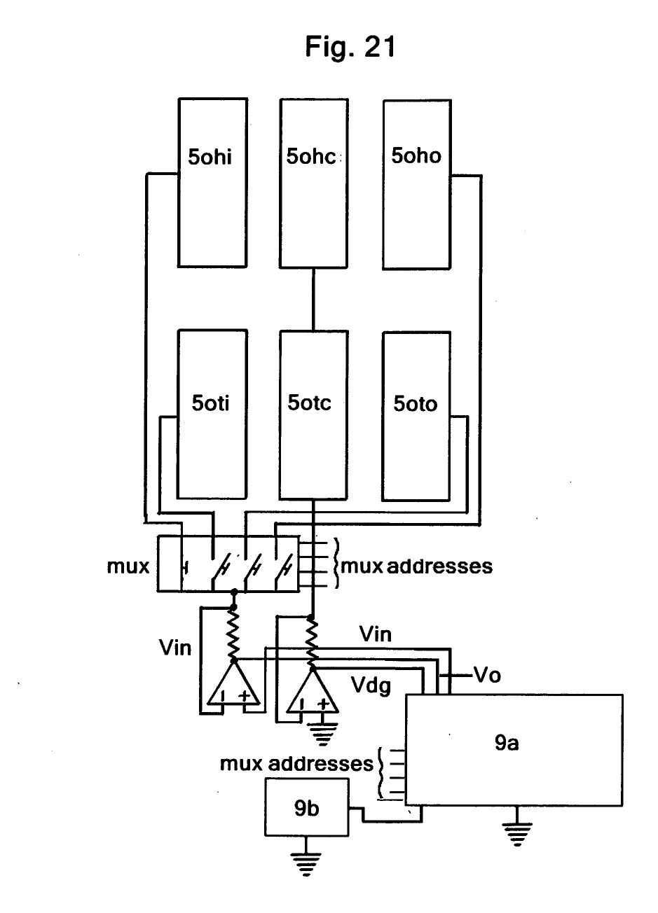

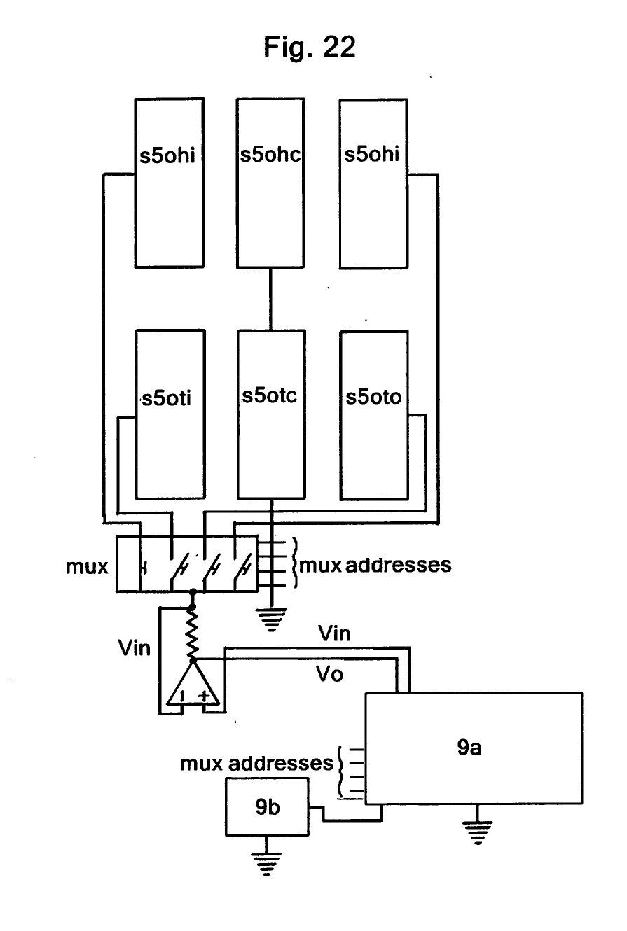

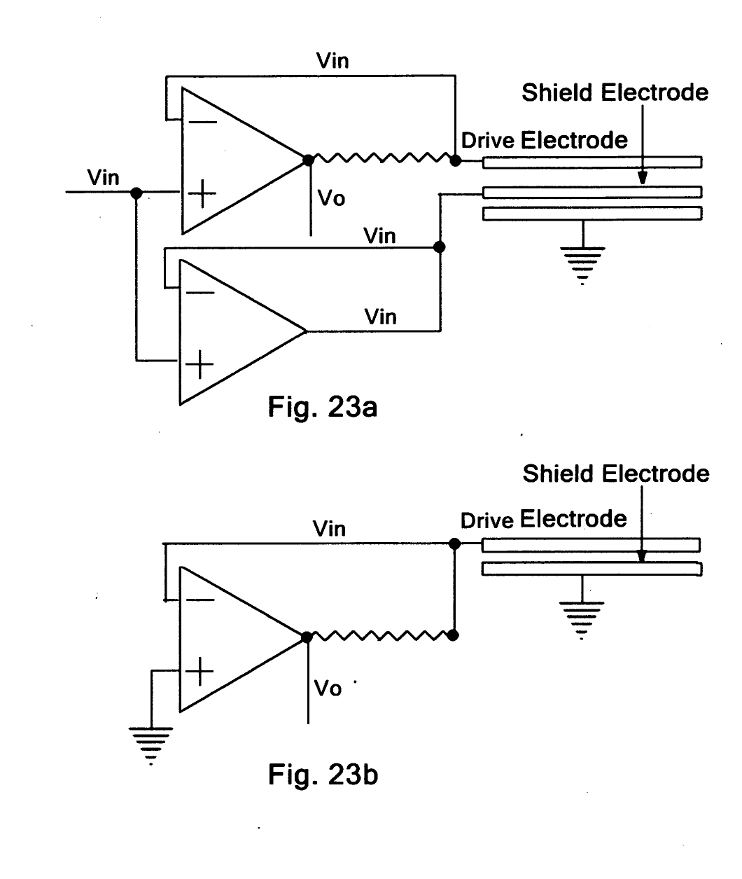

The electronic circuitry [10], [11], [12], [13], [14], [15], [16] will now be examined. We first examine the circuitry driving the sensing electrodes for the force sensors (FIG. 18) and for the shield electrodes (FIG. 19). Next key components in this sensing circuitry are discussed, current measuring sensing electrodes (FIG. 20a) and current measuring driven ground electrodes (FIG. 20b). Next, a version of the circuitry for force sensors which is optimized for low power consumption is discussed with FIG. 21a showing the sensing electrode circuitry and FIG. 21b the shield electrode circuitry. To this point the circuitry for force sensors has been shown and circuitry for the proximity sensors has not. In FIGS. 22, 23, low power consumption circuitry for proximity sensing is shown and it can be seen that the circuitry for proximity sensing is similar to the circuitry for force sensing.

a. Circuitry for Force Sensing as Shown in FIGS. 18, 19 Will Now be Described. The Basic Circuitry for Proximity Sensing is Similar and so Will not be Described at this Time.

As per FIG. 18, a microcontroller, 9a, sends an AC signal, Vin, to op-amps driving each of the force sensing electrodes (5ihi, 5iai, 5iti, 5iho, 5iao, 5ito). We note each op-amp is a voltage following op-amp so the voltages on the force sensing electrodes are the same (Vin). But, we also note each voltage following op-amp has a resister at its output so any current through a force sensing electrode must also pass through the resister. This, in turn, causes the voltage at the op-amp output to boost its output to compensate for the voltage drop across the resister and maintain Vin at the force sensing electrode. The op-amp output also shifts phase to compensate for the phase shift across the resister. Both the voltage drop across the resister and the phase shift across the resister provide information about the force pushing the flexible grounded conductive foil, 1a, towards the sensing electrode serviced by the current measuring op-amp. Simultaneously, all the force sensing electrodes are, each, independently serviced by a current measuring op-amp and each is independently measuring the force pushing the flexible grounded conductive foil towards it. And, since the voltage is Vin at each of the electrodes, we have no cross-talk between sensing electrodes. Thus, each of the sensing electrodes can independently measure force in its local area and we have a map of the forces and force distribution between foot and shoe for any instant in time. In FIG. 18 we see the microcontroller, 9a, is providing AC signal, Vin, to each of the sensing electrodes (5ihi, 5iai, 5iti, 5iho, 5iao, 5ito) simultaneously. The current measuring op-amps of each sensor electrode are also simultaneously adjusting current and phase of current to satisfy the momentary distribution of forces and we have constant updates on the forces between foot and Shoe. The sensor currents and phase shifts are, sequentially, read back into the microcontroller, 9a, through a de-multiplexer with a sequence so much faster than normal exercise that it seems instantaneous. In FIG. 19, we see shield electrodes (s5ihi, s5iai, s5iti, s5iho, s5iao, s5ito) are also driven at the same Vin AC signal as the sensor electrodes. And, since each of the shield electrodes is between a sensor electrode and electrical ground, each sensing electrode is actively shielded from leaking to ground, most of sensing electrode current is directed towards the flexible conductive foil, 1a, and sensor signal to noise is improved. We recall 9b is the power supply and 9f is the wireless (Bluetooth) connection with the IIR in both FIGS. 18, 19.

b. Low Power Consumption Circuitry for Force Sensing (FIGS. 20a, 20b). Circuitry

We will now discuss low power consumption circuitry for force sensing (FIGS. 20a, 30b). Using the circuits according to FIGS. 20a, 20b, we expect significant savings in power. From FIGS. 19 and 20, we see each force sensing electrode and each force shield electrode has an op-amp sending it current. We also know that each op-amp has on the order of twenty (20) bipolar junction transistors (based on Fairchild Semiconductor 741 differential op-amp as per Wikipedia subject op-amp). We know that BJTs use current and dissipate power across the resistors connected to their output and input terminals so we expect reducing the number of op-amps will lower power dissipation and we look to reduce the number of op-amps. In FIG. 20a, we use two (2) op-amps for sensing, rather than the six (6) amps used in the circuit shown in FIG. 18. In FIG. 20b, we use one (1) op-amp for shielding, rather than the six (6) op-amps used in FIG. 19. In total, the low power circuitry (FIGS. 20a, 20b) uses three (3) op-amps rather than the twelve (12) op-amps used in the standard version (FIGS. 18, 19) for a four to one reduction in power consuming components. So we expect a power savings on the order of a 75% reduction.

We now examine how the circuits (FIGS. 20a, 20b) work as opposed to those in circuits (FIGS. 18, 19). In FIG. 18, we use an op-amp to keep each sensing electrode at Vin even as changing current is supplied under changing forces. With FIG. 20a, we select one (1) sensing electrode as the electrode to be serviced by the sensing op-amp and connect the other five (5) sensing electrodes to the shield op-amp, all operating at Vin, but only the sensing electrode being read out by the sensing op-amp circuit Vo. At this point, another sensing electrode is switched to the sensing op-amp, while the previous sensing electrode is switched to the shield op-amp and the process continues. In this way, every sensing electrode can be sequentially measured in sequence and shielded from cross-talk and parasitic losses. As per FIG. 20b, the shield electrodes are all connected, in parallel, to a single shield amplifier so the voltage across each is held at Vin even while the current across each shield electrode varies according to circumstances. We cannot measure the current through shielding electrodes, but we do not need this information to determine our force information.

c. Low Power Consumption Proximity Sensing Circuits (FIGS. 21, 22). [10], [11], [12], [13], [14], [15], [16].

Proximity sensing for the Balance-Assist Shoe typically involves contact with surfaces such as asphalt, concrete, floor tile or wood. These are dielectric insulators, each with a different relative permittivity so the proximity readings will be influenced by the material and the proximity measuring system needs a method to measure the permittivity in real time so as to calibrate the proximity measurements in situ. So, we use a coplanar capacitor configuration as per FIGS. 16a, 16b in which one electrode is a current measuring source, the other electrode is a current measuring ground and an electric field arches between them. When a dielectric material is introduced, the electric field is altered and we have proximity information as described in section 6. Proximity Sensing Governing Equations (above). To make the equations work for proximity sensing of dielectric contact surfaces, we must be able to measure both the current leaving each sensing electrode and the current arriving at the ground electrode from each sensing electrode. This tells us how much of the current from a particular sensor electrode is flowing to a particular ground, how much is being diverted to another ground and what phase shift is incurred in the current that arrives at the particular ground and at what instant of time this occurs. We do not know the phase shift of the current that was diverted to other grounds and we do not care. The circuit shown in FIG. 21 enables us to provide and measure the currents (phase, amplitude and frequency) from any particular sensor electrode to its corresponding ground electrode at any instant. The circuit shown in FIG. 22 provides proper shielding for the sensor electrodes and maximum signal to noise ratio clarity for the proximity measurements. In FIG. 21, we show a situation where microcontroller, 9a, provides an AC signal, with Vin amplitude, to a current measuring op-amp and the Vin output from that current measuring op-amp selectively passes through a multiplexor to sensing electrode 5ohi, which is coplanar with neighboring current measuring ground electrode 5ohc. The voltage, Vo, from the sensing electrode, and the voltage, Vdg, from current measuring ground electrode, 5ohc, feedback into microcontroller 9a where information about the amplitude and phase of the current leaving sensor electrode 5ohi and current arriving at ground electrode, 5ohc are measured and time correlated. By switching through the multiplexor, all the heel and toe coplanar capacitive circuits can be sequenced and ample proximity information can be provided to microcontroller, 9a, for further processing. From FIG. 22, we see a shielding situation in which shield electrode, s5ohi, is driven by the same AC, Vin source as 5ohi, while the nearest coplanar shield electrode, s5ohc, is grounded. Thus, s5ohi shields 5ohi from leaking to ground through parallel electrode, s5ohi, and s5ohc shields 5ohc from collecting electrical current from parallel electrode sources other than 5ohi. This results in optimum signal to noise readings from sensors 5ohi and 5ohc. The FIG. 22 shielding circuit allows the shielding electrodes s5ohi, s5oho, s5oti, s5oto to be selectively activated to shield 5ohi, 5oho, 5oti, 5oto from parallel electrode coupling to ground, while s5ohc, s5otc are hard grounded, thus 5ohc, 5otc are shielded from current leaking from parallel electrodes on the interior of the Shoe and signal to noise ratios of the current measuring ground electrodes is optimized. Cross-talk between heel sensors and toe current-measuring ground electrode is insignificant because they are physically separated by a relatively large distance.

d. Current-measuring sensing electrodes and current-measuring ground electrodes (FIGS. 23a, 23b). Current-measuring sensing electrodes and current-measuring ground electrodes will now be discussed. [13], [16].

1). Current-measuring sensing electrodes (FIG. 23a) will now be discussed. From FIG. 23a, we see a current-measuring op-amp in a voltage follower configuration [13] Thus, current from the current measuring op-amp passes through a resistor at the op-amp output, is feedback to the negative input of the op-amp and continues to a sensor electrode where it couples to ground through capacitance. This requires the input to the sensor electrode to be approximately Vin, to satisfy the voltage follower configuration and voltage is dropped across the resistor between the op-amp output and the voltage follower feedback loop, so the voltage at the op-amp output, Vo, is larger than Vin and can be phase shifted from Vin to account for the voltage and phase drop across the resister. When Vo is measured and compared to Vin, we have a measurement of the current and phase of the current and we know the impedance of the capacitive load, both its amount and its phase.

More precisely:

$${V}_{o} - IR = {V}_{in} - \frac{{V}_{in}}{δ} \\ ( where δ = op \text{-} amp open loop gain \approx 180 , 000 ) \qquad ( eq . 10 )$$

We know Vᵢₙ, R, δ and can measure Vₒ. So we can calculate I

$$I = \frac{( {V}_{o} - {V}_{in} ( 1 - \frac{1}{δ} )}{R} \qquad ( eq . 11 )$$

We also know

$${V}_{in} - \frac{{V}_{in}}{δ} = IZ \\ ( where Z is the load impedance ) \qquad ( eq . 12 )$$

So: we can calculate Z
In our application Z is primarily a capacitance).

We also show a voltage follower driven shield electrode, which actively prevents the sensing electrode from leaking back through the driven shield electrode to ground, but, rather, is reflected back towards current-measuring ground electrode, thereby improving signal to noise ratio.

2). Current-measuring ground electrodes (FIG. 23b) [16] will now be discussed. A current-measuring capability in the ground electrode is important in proximity sensing of dielectric insulating contact surfaces (concrete, ceramic floor tiles, wood floors, rugs, dirt, rocks, plastic, etc.). In proximity sensing of dielectric insulators using electric fields and capacitors, each in a coplanar configuration, it is important that both the sensor electrode and the ground electrode measure the current passing through their respective electrodes. We need to measure the current leaving the sensing electrode and the current arriving at the ground electrode to better understand the object being sensed. When the object is a grounded conductor, very little current from the sensing electrode reaches the ground electrode. When the object is a dielectric insulator, most of the current from the sensing electrode arrives at the ground electrode and the closer the object and the higher the dielectric constant, the greater the current. The current from the sensing electrode and the current arriving at the ground electrode both contain information of current amplitude and current phase. Both are affected by the material being sensed and both are available in our current measuring ground circuit and our current-measuring sensor component.

We want the current measuring ground in FIG. 23b to provide a large Vo from a small voltage drop across R (near zero) so our current-measuring ground is very close to an actual ground. We will now show how this happens. A small current passes through the output resistor to the low impedance output end of the op-amp and on to ground inside the op-amp. In the process, a small voltage is dropped across the output resistor. This voltage is also applied to the negative terminal of the op-amp, which in turn, acts like a virtual ground and pulls current away from the negative terminal and towards the op-amp output terminal.

$$\begin{matrix}Δ I ( \frac{{RR}_{in}}{R + {R}_{in}} ) = Δ V & ( eq . 13 ) \\ Δ V δ = {V}_{o} & ( eq . 14 ) \\ \frac{{V}_{o}}{δ} = Δ V = Δ I ( \frac{{RR}_{in}}{R + {R}_{in}} ) & ( eq . 15 ) \\ \frac{{V}_{o} ( R + {R}_{in} )}{δ ( {RR}_{m} )} = Δ I & ( eq . 16 )\end{matrix}$$

Rᵢₙ=2E6 ohms (typical of op-amps)
δ=180,000 (typical of op-amps)
We choose R=100,000 ohms
For: Vₒ=1 volt

$$\begin{matrix} \frac{{V}_{o}}{δ} = Δ V = \frac{1 volt}{180 , 000} = 5.56 ( E - 6 ) volts & ( eq . 17 ) \\ \frac{{V}_{o} ( R + {R}_{in} )}{δ ( {RR}_{m} )} = Δ I = \frac{1 ( 2.1 E - 6 )}{( 1.8 ) ( 1 ) ( 2 ) ( E + 16 )} = 0.5833 ( E - 16 ) amps & ( eq . 18 )\end{matrix}$$

### H. SUMMARY AND CONCLUSIONS

A Balance-Assist Shoe System requires Shoes capable of sensing their proximity and alignment to a contact surface and capable of sensing the forces between Shoe and foot during contact. Several sensing technologies can be used so at this point in the discussion we simply assume the sensors work and discuss where each should be located on a Shoe and what it should be capable of measuring. The Shoes must measure and map proximity to a contact surface (typically asphalt, concrete, wood, ceramic tile, dirt, sand, rocks, etc.) against locations on the bottom of the Shoe and map contact forces between Shoe and foot, A system is required to make proper use of the instrumented Shoes so the discussion next focuses on a proper support system.

A proper support system includes: an internet link that enables the Shoe measurements to be time referenced and Route to be tracked by GPS, a Headset system that provides an early warning system against being hit by unseen vehicles, a Playback & Analysis system that provides 3-D visual models and stop frame simulations of recorded Shoe motions and forces and a PC Media Center System that enables the operator to work on a computer, with full sound and without disturbing others, while a warning system in the headset alerts the operator to significant external activities. The discussion goes through the entire system, component by component and explains how each component works and how the system works. The discussion also explains the capabilities the system provides. The technology required to make the system requires only available technology, though the way it is applied is novel at times.

The discussion returns to Balance-Assist Shoes using capacitance sensing for both proximity and force, where Shoe proximity to a contact surface is mapped against locations on the bottom of the Shoe and the dielectric constant of the contact surface material can be measured in situ and the proximity measurements calibrated in situ, whereby the forces can be mapped against the bottom of the foot and force measurements can be calibrated in situ.

Balance-Assist Shoe using capacitive proximity sensing with coplanar electrode capacitors in the heel and toe contact surfaces with current measuring sensor electrodes and current measuring ground electrodes whereby current from the sensor electrode and current to the ground electrode can be independently measured in frequency, amplitude and phase. This arrangement facilitates measuring proximity to dielectric insulator contact surfaces (concrete, asphalt, wood, ceramic tile, dirt, sand, rocks, etc.). Active shielding, also in coplanar electrode form, increases the signal to noise ratio and proximity range of each proximity sensing, coplanar electrode capacitor. The heel and toe regions of each Shoe constructed of electrically conducting and insulating rubber like material whereby they can function both as coplanar electrodes and, simultaneously, as Shoe wear surface and motion control contact surface.

Balance-Assist Shoes are next discussed which use capacitive force sensing with parallel conductive electrodes, where the parallel conductive electrodes are separated by an insulator dielectric with spring constant, where the displacement of the electrodes is, independently measured according to the force applied at that particular location, where one electrode is a grounded conductive foil common to all the current-measuring sensing electrodes and no current-measuring ground sensor electrodes are needed.

Finally, low power consumption circuits, unique to the capacitive proximity sensing method are discussed, along with other low power consumption circuits, unique to the capacitive force sensing method. These provide high performance, with maximum performance life and minimal power consumption.

Having thus shown and described what is at present considered to be the preferred embodiment of the invention, it should be noted that the same has been made by way of illustration and not limitation. Accordingly, all modifications, alterations and changes coming from within the spirit and scope of the invention as set forth in the appended claims are herein to be included.

What is claimed is:

1. A system for measuring the proximity and alignment of a shoe with respect to ground contact prior to and during contact, for measuring the distribution of contact forces on the wearer's foot and for communicating said force and alignment information, as a time sequence, to the operator, comprising:
a sensor system that senses and measures said shoe pre-contact, partial contact and full contact conditions, along with the alignment of said shoe with respect to said ground contact surface and the distribution of forces between the operator foot and said shoe;
a shoe that time sequences and selectively records measured data;
a power system, a microcontroller system with internet connection, a switching network of electronic circuits, a data recording and playback system and a wireless communication system between the said shoe microcontroller system and the operator a system of two shoes that provides time sequenced proximity, alignment and force distribution data of each shoe and that relates said data to provide timing information on how the two shoes operate as a system;
an exercise system, wherein an athlete can wear a situation awareness headset and can monitor his/her performance and/or be entertained without danger of being placed in danger by being distracted;
a playback and performance analysis system with internet connection, wherein a playback system allows the viewer to selectively visualize reruns of previous activity in full speed, slow motion or still frame sequence, wherein sensor data can be selectively provided and wherein analysis can be selectively provided, wherein software capabilities can be added as updates and software applications.

2. A shoe system, according to claim 1, wherein said sensors can be removed and replaced as one or more modules.

3. A shoe system, according to claim 2, wherein said power system, said microcontroller system, said internet connection, said switching network of electronic circuits, said data recording and playback system and said wireless control system are components of a removable and replaceable electronics module.

4. A playback and performance analysis system, according to claim 3, with computer, internet connection, solid modeling graphics, animation capabilities and application software, therein, whereby data from each of two said electronics modules can downloaded, viewed and analyzed, whereby said viewing is in the form of solid modeling graphics animations, with stop and step frame capabilities, wherein said application software includes a question and answer capability, wherein the two shoes can be viewed individually or as a system, wherein the two shoes can be analyzed individually or as a system.

5. A playback and performance analysis system, according to claim 4, whereby each said removable and replaceable electronics module can communicate wirelessly with an external computer, wherein said external computer can acquire said playback and performance analysis capabilities by software download, wherein said software download can be either by portable storage device or by internet connection, whereby playback and analysis can be performed while one or both said removable and replaceable electronics modules remains in its shoe.

6. A shoe that measures pre-contact, partial contact, full contact and alignment with respect to a contact surface by measuring capacitance.

7. A shoe, according to claim 6, wherein the heel of the shoe is comprised of individual electrically conductive electrodes, separated by electrical insulators, wherein the toe of the shoe is comprised of electrically conductive electrodes separated by electrical insulators and wherein said electrodes and insulators also perform the typical traction, stability and cushioning mechanical functions of shoes in everyday use.

8. A shoe, according to claim 7, wherein said conductive electrodes in the heel are arranged with driven source electrodes on the outer and inner sides of the heel and a current-measuring ground electrode is located between the driven source electrodes, wherein said conductive electrodes in the toe are arranged with driven source electrodes on the outer and inner sides of the toe and a current-measuring electrode is located between the driven source electrodes, whereby electrical fields are formed in the heel and the toe that arch between the current-measuring driven source electrodes and the current-measuring ground electrodes, whereby the proximity of a dielectric or conductive material alters the electric fields, whereby the displacement currents are changed and measured, whereby the dielectric constant of the contact surface material and the proximity to that surface and alignment with that surface can be determined.

9. A shoe, according to claim 8, wherein a multilayer, flexible printed circuit board supplies electrical voltage and current to the said electrically conductive shoe heel and toe electrodes.

10. A multilayer flexible printed circuit board for proximity sensing, according to claim 9, wherein a first outer surface of separated electrodes is followed by an insulation layer, followed in turn by a layer of separate lead lines each connected to an electrode, followed in turn by an insulation layer, followed in turn by a layer of shield electrodes, followed in turn by a second insulation layer, followed in turn by an outer surface layer electrical ground, whereby the outer electrodes of said first outer surface can be independently supplied with controlled electrical current and the inner electrodes will perform as current measuring ground electrodes, wherein said electrodes supplied with controlled current are actively shielded from leaking to said ground layer and said current-measuring ground electrodes are shielded from leakage from said driven shield electrodes by ground electrodes, wherein said ground layer shields other activities in the shoe system from being adversely effected by proximity sensing activities.

11. A proximity sensing electronics system which supplies and controls electrical voltage and current to a multilayer flexible printed circuit board, according to claim 10, wherein said electronics system reads, records and acts on return signals from said multilayer printed circuit board, wherein said proximity sensing electronics system has a microcontroller, a current-measuring driven source first op-amp, a first multiplexor, a current-measuring-measuring ground second op-amp and a driven shield third op-amp, wherein said microprocessor provides a current to the input of said current measuring first op-amp, receives a signal from the output terminal of said first op-amp and receives a signal from the output terminal of said second op-amp, wherein said microcontroller provides an input current to said third op-amp and provides command signals to said first and second multiplexors, wherein the input of said first multiplexor is connected to the feedback loop of said current measuring first op-amp and the outputs of said first multiplexor are connected to the said driven source electrodes of said multilayer printed circuit board, wherein the input of said second multiplexor is connected to the feedback loop of said third op-amp and the outputs of said second multiplexor are connected to the said driven shield electrodes of said multilayer flexible printed circuit board, wherein the input of said current-measuring second op-amp is connected to ground at its input and is connected to the said current measuring ground electrodes of the said multilayer flexible printed circuit board at its feedback loop, wherein said microcontroller selects a said driven source electrode and a corresponding said driven shield electrode and commands said first and second multiplexors to close a switch in each to make the proper connections and to open the remaining switches, whereby an electric field is established between said the selected driven source electrode and its neighboring said current-measuring ground electrode, whereby the proximity of a dielectric material object in said electric field is detected and measured by the change in current measured at both the said first op-amp and said second op-amp output terminals, wherein said current changes have changes in both amplitude and phase and both provide information to said microcontroller, whereby electric fields can be created and collapsed, one at a time, for all the viable said driven source, current-measuring ground combinations, whereby an array of proximity sensors can be scanned, whereby the number of op-amps is minimized and power consumption is minimized.

12. A shoe, according to claim 6, whereby force distribution is measured between foot and shoe, wherein an array of current-measuring, driven source electrodes creates electric fields between each said driven source electrode and an electrically grounded conductive foil, separated from said current-measuring driven source electrodes by a sheet of dielectric insulating material with a spring constant, whereby an array of parallel electrode capacitors is formed, whereby, force between foot and shoe compresses said dielectric insulating material and changes the capacitance between said foil and said current-measuring driven source electrodes, whereby current in effected driven source electrodes is changed and force is measured, wherein said foil and dielectric insulating material can deform to the distribution of force between foot and shoe, whereby the forces on the foot can be mapped, wherein a driven shield is between said sensors and electrical ground, whereby said force measurements have enhanced signal to noise ratio, wherein a multilayer flexible printed circuit board provides the driven source electrodes, the lead lines to each of said driven source electrodes, the driven shield layer, the ground layer and the insulation layers that separate said electrodes, lead lines, driven shield layer and ground layer from each other.

13. A force sensing multilayer flexible printed circuit board, according to claim 12, wherein an array of said driven source electrodes is contained in an outer layer, followed in turn by an insulation layer, followed in turn by a layer containing separate lead lines, each connected to a driven source electrode, followed in turn by an insulation layer, followed in turn by a driven shield layer, followed in turn by an insulation layer, followed in turn by a ground layer.

14. A force sensing electronics system which supplies and controls electrical voltage and current to a force sensing multilayer flexible printed circuit board, according to claim 13, wherein said force sensing electronics system has a microcontroller, a current-measuring driven source first op-amp, a voltage follower second op-amp, a voltage follower third op-amp, a first array of solid state relays and a second array of solid state relays, wherein the inputs of said first array of solid state relays are connected in parallel to the said first op-amp at its feedback loop output and each output of said first array of solid state relays is connected to a said driven source electrode, wherein the inputs of said second array of solid state relays are connected in parallel to the said second op-amp at its feedback loop output and the outputs of said second array of solid state relays are each also connected to a said driven source electrode, whereby each said driven source electrode has two methods to have the input voltage supplied, wherein said the output terminal of said first op-amp is connected to an input in said microcontroller, wherein op-amps are minimized and power loss is minimized.

15. A multilayer flexible printed circuit board that services both proximity sensing and force sensing and where the proximity sensing portion is according to claim 10.

16. A multilayer flexible printed circuit board that services both proximity sensing and force sensing and where the force sensing portion is according to claim 13.

17. An electronics system which supplies and controls electrical voltage and current to a multilayer flexible printed circuit board which services both proximity and force sensing and which measures the said forces and proximity distances, wherein the proximity measuring electronics system is according to claim 11.

18. An electronics system which supplies and controls electrical voltage and current to a multilayer flexible printed circuit board which services both proximity and force sensing and which measures the said forces and proximity distances, wherein the force measuring electronics system is according to claim 14.

19. A situation awareness headset according to claim 1, whereby an operator can listen to sound through internal ear phones while external ear microphones listen and alert the operator to the sounds of important outside activities, including dangerous approaching vehicles, wherein, each ear has a device that sends sound into the ear, a device that listens to sound originated outside the ear and a means to keep the outside sound from interfering with operator hearing, wherein said outside sound is interpreted by a microprocessor system and is classified as sufficiently important to alert the listener or not, wherein outside sounds judged important are interpreted as to what is judged to be causing them, what direction they are coming from, how fast the source of the sounds is approaching and the urgency of the situation, wherein the listener is alerted to outside sounds judged to be important and is informed of the situation judged to be causing said important outside sounds, wherein said outside sounds judged to be important are recorded, along with the time of occurrence and the alert sent to the listener, wherein the listener is informed of recorded outside sounds from private conversations, wherein said private conversations are deleted after a short period of time, unless the listener saves them, wherein recorded important events can be transferred to other storage means and the said situational awareness headset can be cleared for renewed duty, wherein a microphone digitizes the operator's voice and a local Wi-Fi connection, whereby said operator can interact with other digital devices.

20. An exercise system, according to claim 19, whereby time correlated data is gathered and recorded about shoe performance, GPS route and said situational awareness headset event recordings, whereby the human operator is interactively involved, informed, entertained and protected, wherein said situation awareness headset, is local Wi-Fi linked with said performance measuring shoes and an internal interactive router device that has an internet connection and a local Wi-Fi connection with said shoes and said headset.

21. A playback & analysis system, according to claim 20, whereby recorded performance from said exercise system can be played back and analyzed, wherein a personal computer can be added to said playback & analysis system, wherein said personal computer has internet and local Wi-Fi links to said exercise system, wherein said playback & analysis system personal computer has the capability to playback simulations of exercise using pictorial 3-D simulations, with stop frame capabilities, wherein said playback & analysis system has a applications library that provides said playback simulations of exercise.

22. A PC media center, according to claim 19, whereby said situation awareness headset can be used with a personal computer with internet and local Wi-Fi connections to operate said computer with full audio features without disturbing others and to remain informed of important outside activities involving audio while wearing a headset, wherein said situational awareness headset has a software application that recognizes someone is trying to speak to the operator and plays that sound back into the ears of the operator, with background noise removed and the sound to each ear in proportion to how it is received by said headset, wherein said software application recognizes public service announcements and plays that sound back into the ears of the operator, with background noise removed and the sound to each ear in proportion to how it was received by said headset, wherein the speaker microphone of said headset can be used to carry on cell phone conversations by going through the personal computer and through the personal computer internet link to a second party, wherein said conversation by said operator are sent over the internet with background noise removed and said conversation received is heard by the operator with local background noise removed, wherein text form of said conversations is available on demand.

23. A situational awareness headset system, according to claim 22, wherein said situational awareness headset has an internet connection, whereby said headset speaker microphone can be used to carry on cell phone conversations with a second party by going from said headset to said second party by way of the internet, wherein said conversation by said operator are sent over the internet with background noise removed and said conversation received is heard by the operator with local background noise removed, wherein text form of said conversations is available on demand and can be applied through a connected system with a display.

24. A situational awareness headset, according to claim 23, whereby said headset digitizes and records said conversations and public service announcements, wherein said recorded conversations include both the operators words and the words of the other party or parties, wherein said conversations are automatically purged within a short period of time unless said operator specifically decides otherwise, wherein said operator is informed of the privacy issues and their legal ramifications prior to said headset executing a save order.
